(19) United States
(12) Patent Application Publication
(10) Pub. No.: US 2011/0037953 A1
(43) Pub. Date: Feb. 17, 2011

(54) MICRO-PROJECTOR

(75) Inventors: Zvi NIZANI, Nofit (IL); Meir ALONI, Herzelia (IL); Shimon YALOV, Ashdod (IL); Uzi RACHUM, Beer Sheva (IL); Jacob RAND, Herzlia (IL)

Correspondence Address: Browdy and Neimark, PLLC, 1625 K Street, N.W., Suite 1100, Washington, DC, 20006, US

(73) Assignee: EXPLAY LTD., HERTZLIYA PITUACH (IL)

(21) Appl. No.: 12/731,860

(22) Filed: Mar. 25, 2010

Related U.S. Application Data
(63) Continuation-in-part of application No. PCT/IL2008/001300, filed on Sep. 25, 2008.
(60) Provisional application No. 60/974,958, filed on Sep. 25, 2007.
(60) Provisional application No. 61/052,855, filed on May 13, 2008.
(60) Provisional application No. 61/085,026, filed on Jul. 31, 2008.

(51) Int. Cl. G02B 27/48; G03B 21/14

(52) U.S. Cl. 353/38

(57) ABSTRACT

The present invention provides a projection display comprising an illumination system comprising at least one laser source unit and configured and operable for producing one or more light beams; a spatial light modulating (SLM) system accommodated at output of the illumination system and comprising one or more SLM units for modulating light incident thereon in accordance with image data; and a light projection optics for imaging modulated light onto a projection surface. The illumination system comprises at least one beam shaping unit comprising a Dual Micro-lens Array (DMLA) arrangement formed by front and rear micro-lens arrays (MLA) located in front and rear parallel planes spaced-apart along an optical path of light propagating towards the SLM unit, the DMLA arrangement being configured such that each lenslet of the DMLA directs light incident thereon onto the entire active surface of the SLM unit, each lenslet having a geometrical aspect ratio corresponding to an aspect ratio of said active surface of the SLM unit.

### FIELD OF THE INVENTION

The present invention relates to projection display systems and particularly to a compact mobile projection display systems, compatible with the portable electronic devices.

### BACKGROUND OF THE INVENTION

Projection display systems have conventionally been used for displaying enlarged images in meetings, for entertainment purposes, personal and automotive applications, and the like. In recent years, projection display systems have advanced into the field of handheld and mobile devices with image/video and Internet-surfing applications, such as mobile phones, PDAs, portable media players, compact memory devices, companion devices, communication networks equipment, laptop and pocket personal computers, GPS navigators. However, the small-size display screen, used in handheld devices, remains a bottleneck for such applications. For example, a graphical HTML page or a high-resolution image/video cannot be properly displayed on these display screens due to their small size. A digital picture data is actually trapped inside the mobile hand held devices. Thus, in order to truly appreciate the quality of a high-resolution image/video, or to do an effective Internet surfing, the users would prefer a larger display that can be achieved by using projection display systems. The screen-size in projection display systems is not limited by the dimensions of mobile device and may reach dimensions from several inches up to tens of inches.

A projection display system, in general, comprises primary illumination sources, usually Red Green and Blue (RGB), associated with light collection optics, some light delivery scheme which combines light of different colors and forwards light to a spatial light modulator (SLM), and a projection lens unit. The SLM spatially modulates the light illuminating it according to input video signal. In some configurations, a common SLM is used for modulating light of multiple channels (multiple colors). In other configurations, each channel is associated with its own SLM. The Spatial Light Modulator (SLM) or imager is used for the modulation of light, either through light transmission or through light reflection. The SLM is a matrix of N×M pixels, modulated electronically to transfer (transmit/reflect) or block a light in synchronization with light sources pulses. The modulation of the light coming from the illumination system is done according to the image data required for creating an image in a sequence of subframes each containing N×M pixels, each with several tens or hundreds, even thousands, of gray levels. To this end, the SLM(s) is/are operated by a corresponding image-related signal. One of the SLM types used in the projection display systems is based on liquid crystal layers controlling the polarization state of each pixel, to display the electronic signals as proper spatially modulated image after passing through an analyzing polarizer. Transmissive liquid crystal micro-displays (LCD), liquid crystal on silicon (LCOS), transmissive LCOS (T-LCOS) are the most wide spread examples of the liquid crystal SLMs. Another SLM type is the digital micro-mirror device (DMD), controlling the position of a micro-mirror at each pixel for directing a light either to projection lens or to an absorbing screen. The spatially modulated image is enlarged and projected on a distant surface by a projection lens.

The illumination sources can be, for example, tungsten-halogen lamps, high-density discharge (HID) lamps or solid-state lighting such as Light Emitting Diodes (LED) and lasers, including laser diodes, Vertical Cavity Surface Emitting Lasers (VECSELs) and diode pumped solid state (DPSS) lasers. Single mode laser light sources in the red spectral band are well known and produced in high volume for the DVD industry, but should be used in arrays to provide sufficient output powers. With regards to green laser sources, the green laser diodes are not yet commercially available, but the diode pumped solid state (DPSS) lasers with frequency doubling have already reached a peak power exceeding 50 mW. Blue laser diodes are starting to be commercially available on the market.

Projector systems based on high power lamps, LEDs or other incoherent sources may feature high etendue (i.e. product of the squared beam divergence over source area) that causes low collection efficiency of the projector optical system due to limited F-number of the illumination system and projection lens. As a result, a greater amount of power consumption is required at the illumination source for the sufficient amount of brightness of the projected image. Furthermore, the design of highly uniform LED or lamp illumination on the compact SLM is not trivial. Therefore projector systems based only on high power lamps, or other incoherent sources are quite bulky, difficult to handle, limited in their mobility and therefore might not be down-scalable to very compact portable handheld projection devices.

Some generic solutions for enabling miniaturization and providing high-quality performance of the projection display system have been developed and are disclosed in WO07060666, WO05036211, WO03005733, WO04084534, WO04064410, all assigned to the assignee of the present application.

### GENERAL DESCRIPTION

A mobile hand held version of projection displays imposes considerable limitations on the system design, configuration and technologies. Common requirements for the mobile projection display include battery operation, passive heat removal, small weight and size (inducing a requirement for compact optical dimensions) and relatively low cost, combined with still high brightness and quality of the projected image. These requirements result inter alia in a very special choice of light sources and optics. Choice of light sources, having high spatial coherence, requires a special care for the granularity and speckle reduction.

The present invention provides a novel compact projection display (sometimes termed “micro-projector”, “nano-projector”, “pico-projector”) enabling its use with (e.g. incorporation into) mobile handheld electronic devices.

According to one broad aspect of the present invention, the projection display comprises an illumination system comprising at least one laser source and configured and operable for producing one or more light beams; a spatial light modulating (SLM) system accommodated at output of the illumination system and comprising one or more SLM units for modulating light incident thereon in accordance with image data; and a light projection optics for imaging modulated light onto a projection surface. The illumination system comprises at least one, preferably telecentric, beam shaping unit comprising a Dual Micro-lens Array (DMLA) arrangement formed by front and rear parallel planes spaced-apart along an optical path of light propagating towards the SLM unit. The DMLA arrangement is configured such that each lenslet of the DMLA directs light incident thereon onto the entire active surface of the SLM unit, each lenslet having a geometrical aspect ratio corresponding to an aspect ratio of said active surface of the SLM unit.

Preferably, the lenslets of the DMLA define a rectangular aperture.

The matching between the aspect ratio of the lenslet and that of the active surface of the SLM optimizes the efficiency of the illumination system. It should be noted that the optimized efficiency of the illumination system provides a sufficiently bright image at limited power consumption and small footprint (25×25 mm max) and volume (3 to 5 cc) of the optical unit.

It should also be noted that beam shaping, used herein refers to optical processing of a light beam providing spatially uniform light intensity within a desired beam cross section, aimed at providing uniform illumination of the SLM active surface/region. The beam shaping unit may be configured as a diffractive optical element, a refractive micro-optical element or an array of such elements. The beam shaping unit is configured to include a dual micro-lens array (DMLA), having front and rear (co-aligned) micro-lens arrays (MLA). Such front and rear MLAs may be located on both sides of a single substrate having a predetermined thickness, or spaced from one another by a predetermined air gap. Preferably, the focal plane of the front MLA coincides with the principle plane of the rear MLA.

The small size of the projection display of the present invention is achieved by significantly reducing the optical path of light within the device as well as reducing the cross-section of a light beam involved in the illumination and projection path. The illumination system of the projection is configured to direct most of the power generated by a light source unit towards a spatial light modulator (SLM) with the following properties: high spatial uniformity, limited numerical aperture and preferably telecentric structure of the rays within the dimensions of the SLM active surface, substantial reduction of the near field and far-field speckle effects.

The illumination system comprises one or more laser sources and optionally also a LED source. In one of the embodiments, light of three primary colors provided by two laser sources and one LED is used.

In another embodiment, three laser sources, providing light of three primary colors, are used. The use of laser sources provides monochromatic light which is well defined in directions of propagation and enables manufacturing of a very compact device. However, the laser source requires special beam shaping and speckle reduction techniques. The creation of a primary speckle pattern can be observed on the surface of a screen, when a coherent beam of light passes through an optical system. The primary speckle pattern is caused by the random interference between different light beams of the projected coherent light thus reducing the image quality. The projection display of the present invention is configured for eliminating or at least significantly reducing the speckle effect by the use of a de-speckling unit and superimposing on the SLM a set of several beams each of them illuminating all the active surface of the SLM. In particular, the illumination system is configured for reducing a speckle effect in the laser light. The illumination system may comprise at least one de-speckling unit accommodated in the optical path of the at least one laser beam upstream of the DMLA arrangement. The de-speckling unit performs a speckle reduction based on a concept of time averaging of the speckle patterns, while light scattering element (diffuser) produces a light scattered pattern randomly varying in both space and time, thereby reducing the speckle effect. This diffuser, also called a “pupil diffuser” is located within the illumination system of the projection display, in the optical path of at least one laser beam upstream of the beam shaping DMLA arrangement.

In some embodiments, the de-speckling unit comprises a continuously displaceable diffuser. The continuously displaceable diffuser may comprise a rotatable scattering surface. The diffuser may be configured and operable to define a diffusing angle such that a sum of divergence of light incident on the diffuser and the diffusing angle of the diffuser is smaller than a double angle defined by numerical aperture NA of the lenslet i.e. 2 arc sin (NA).

The displaceable diffuser may be located in the optical path of light propagating from the laser source unit towards the DMLA arrangement being spaced from the DMLA a certain distance selected so as to avoid imaging of the scattering surface of the diffuser onto the DMLA.

In some embodiments, the illumination system comprises at least one collimator at the output of the at least one laser source, the continuously displaceable diffuser being located in the optical path of the collimated light.

The displaceable diffuser may comprise one of the following: a voice coil diffuser, rotationally vibrating diffuser, rotating disc diffuser, and tubular rotating diffuser.

In some embodiments, the laser source unit, the de-speckling unit and the DMLA are configured and operate together such that that the dimension of the cross-section of the light spot on the de-speckling unit is smaller than the dimension of the SLM active surface.

The DMLA may be configured and operable to contribute to the speckle reduction effect.

The de-speckling unit and the preferably telecentric beam shaping unit might be shared by all or part of the primary color channels. Alternatively, the primary color channels may have their own such units. In order to shorten the optical path of light within the device, a telephoto design of the lenses may be used in laser illumination channels. Therefore, the illumination system may comprise a telephoto negative lens, such that the optical path of light within the projection display is reduced while the effective focal length of the projection display is maintained.

According to some embodiments of the invention, the projection display is configured in a color sequential scheme with independently temporally modulated and spatially combined light beams of every and each colors, with a single SLM associated with a plurality of wavelength illumination channels, and accordingly with a single diffuser and a single DMLA common for all the illumination channels. The beam shaping may be performed before the combining of the light beams and/or after that.

In some embodiments, every lenslet of the front MLA creates a separate focused beam on the rear MLA which outputs a respective parallel beam. The rear MLA is configured and operable as a field lens correcting the chief propagation of each beam incident on it. The thickness of the DMLA is selected such that the focus of the front MLA is substantially positioned on the surface of the rear MLA.

The laser source unit may comprise a light source array associated with collimation optics such that the plurality of beams emitted by the light source array is collimated into one collimated beam; the collimation optics collimating first the slow axis and then the fast axis of the collimated beam.

Moreover, the projection display has compact features in which the light propagation path through the projection display substantially does not exceed a few tens of millimeters.

In some embodiments, the projection display comprises a set of substantially identical condenser and field lenses oriented in opposite directions, such that the condenser lens is located in proximity of the DMLA and the field lens is located at the rear focal plane of the condenser lens, which is in a close proximity to the SLM.

The beam shaping unit may comprise a circulizer located upstream of the DMLA with respect to a light propagation direction towards the SLM. The circulizer may comprise at least one prism. Alternatively, the circulizer may comprise a fill diffuser and a collimating fill lens at the output of the fill diffuser.

The projection display of the present invention may also comprise a color sensor configured and operable to monitor and correct the white balance of the laser source unit. The color sensor may be located at a passive output of a beam combiner combining at least two light channels.

### BRIEF DESCRIPTION OF THE DRAWINGS

In order to understand the invention and to see how it may be carried out in practice, a preferred embodiment will now be described, by way of non-limiting example only, with reference to the accompanying drawings.

FIG. 1A illustrates a general block diagram of projection display of the present invention;

FIG. 1B represents a schematic block diagram of the illumination system of the projection display;

FIG. 2 illustrates a schematic view of an example of a projection display;

FIG. 3 shows a front view of a dual micro-lens array (DMLA);

FIG. 4 illustrates a light beam propagation scheme inside a DMLA;

FIG. 5 illustrates the position of a spot of the incident light on a DMLA surface;

FIG. 6 illustrates details of a light beam propagation scheme inside a DMLA;

FIG. 7 shows an example of a partial view of a DMLA illumination unit of a projection display;

FIG. 8 shows a general mechanical layout of a de-speckling unit configured as a voice-coil vibrating diffuser;

FIG. 9 shows a general mechanical layout of a de-speckling unit configured as a rotationally vibrating diffuser;

FIG. 10 shows a general mechanical layout of a de-speckling unit configured as a rotating disc diffuser;

FIGS. 11A and 11B shows a general mechanical layout of a de-speckling unit configured as a tubular rotating diffuser;

FIG. 12 illustrates the telephoto principle;

FIG. 13 illustrates a telephoto optical arrangement associated with a DMLA and a transmissive LCD panel;

FIG. 14 represents a green light source configured as a diode pumped solid state laser mechanically assembled with a beam expander;

FIG. 15 illustrates a green illumination channel;

FIG. 16 represents an example of an array of laser diode light sources;

FIG. 17 illustrates an example of an illumination channel with array of laser light sources;

FIG. 18 illustrates an example of a laser light source combined of two separate lasers;

FIG. 19 illustrates another configuration of a laser light source combined of two separate lasers;

FIGS. 20A and 2013 represent a single high power LED-type light channel;

FIG. 21 represents an example of a single-color laser channel of the projector display system associated with a LCOS-type SLM;

FIG. 22 illustrates a LCD projection display system of the present invention with combined laser and LED light sources;

FIG. 23 illustrates a LCOS based projection display of the present invention with combined laser and LED light sources wherein red laser source is the pair of red lasers with the reflective periscope;

FIG. 24 illustrates a cross section view of an example of a projection display including a prismatic beam circulizer;

FIGS. 25A-25C illustrate three different configurations of a prismatic beam circulizer;

FIGS. 26-28 illustrate three different implementation of a prismatic beam circulizer in projection display;

FIG. 29 illustrates a circulizer configured as a fill diffuser;

FIGS. 30-31 illustrate a two different configuration of the projection display comprising a fill diffuser;

FIG. 32 illustrates a sample of a fill lens; and;

FIGS. 33A-33B illustrates the incorporation of a color sensor in the projection display near a dichroic beam combiner (33A) and near a PBS (33B).

FIG. 34 illustrates another example of the light propagation scheme in the projection display system of the present invention.

FIG. 35 illustrates an example of a beam circulizer comprising a hexagonal microlens array (HexMLA).

FIG. 36 illustrates the layout of the lens packing in the HexMLA.

FIG. 37 illustrates optical engine arrangements according to the invention exploiting the hexagonal MLA.

FIG. 38 illustrates another example of the system of the present invention utilizing hexagonal MLA.

### DETAILED DESCRIPTION OF PREFERRED EMBODIMENTS

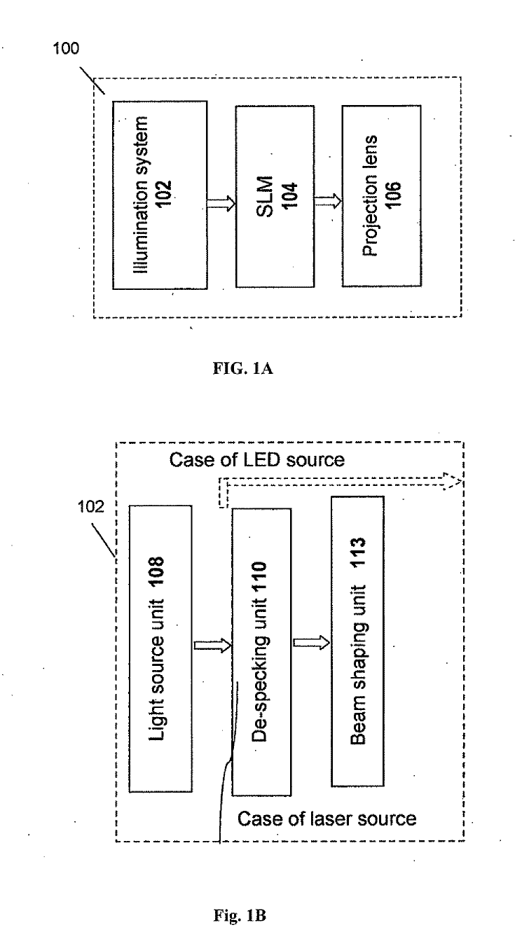

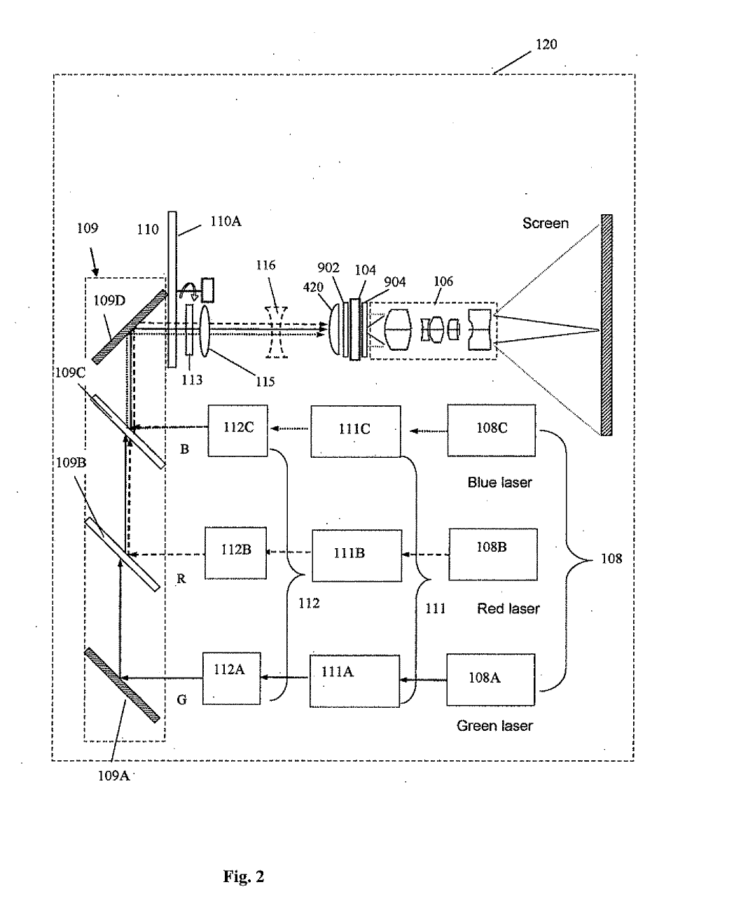

Reference is made to FIG. 1A illustrating a schematic representation of an example of a compact projection display 100 of the present invention. The projection display includes an illumination system 102 for producing one or more light beams, e.g. multiple light beams of different wavelengths, typically primary colors (RGB) or YRGB or a wider set of colors; a spatial light modulator (SLM) system 104, which may be configured as LCD, T-LCOS, LCOS or DMD panel; and a projection optics, typically a lens unit 106. It should be noted that the projection display may include a separate SLM for each light illumination channel, or a common SLM for at least two channels.

To facilitate understanding, the same reference numbers will be used for identifying some of the components that are common in all the examples.

Reference is made to FIG. 1B illustrating a block diagram of the illumination system 102 comprising a light source unit 108 which in the present example has a number of light sources defining several primary color channels, a de-speckling unit 110, and a beam shaping unit 113.

The provision of de-speckling unit 110 is associated with the following: While laser sources can be optimized for use in projection display illumination and imaging systems, they feature a high degree of the spatial coherence and a consequent problem of speckle exists. Speckle produces random spots and grains that substantially reduce a visual quality of the image on the screen. Accordingly, a substantial reduction of the contrast of the speckles is required for projection display exploiting lasers. For that, the laser light beams of the light sources 108 are directed onto the de-speckling unit 110, which produces a light pattern varying in time and space, to thereby reduce the speckle effect.

Reference is made to FIG. 2, illustrating a schematic view of a full laser projection display system 120 according to an example of the invention. The projection display system 120 comprises an illumination system including a light source unit 108 which in the present example is formed by three laser sources 108A, 108B and 108C generating three light beams of different primary color wavelengths (in red, green and blue regions of the visible optical spectrum). In the present example, multiple light channels are associated with a common time sequential SLM system 104. Thus, three light beams from the light sources 108A, 108B and 108C are directed towards a light collecting unit 111 formed by three separate light collectors 111A, 111B and 111C and collimators 112A, 112B and 112C, such that the collected and the collimated light beams propagate towards a beam combiner 109. The light collecting and collimator units 111, 112 are configured for collecting and collimating the light from the laser light source unit 108 and are associated with cylindrical, spherical or toroidal lenses having high numerical apertures (NA). The beam combiner 109 includes two regular reflectors (mirrors) 109A and 109D and two wavelength-selective elements (dichroic mirrors) 109B and 109C. The wavelength-selective elements may be implemented as dichroic coatings on a substrate surface, which may be configured as plate or cubic element.

In this non-limiting example, the light from laser 108A has green color and is directed towards mirror 109A through the light collecting unit 111A and collimator 112A. The mirror 109A reflects the collimated green beam towards the red dichroic mirror 109B. Simultaneously, the red beam from the red laser 108B is directed towards the red dichroic mirror 109B through the light collecting unit 111B and collimator 112B. Thus, the dichroic mirror 109B receives the green and the red beams and directs them in transmission and reflection modes to the blue dichroic mirror 109C. The blue light beam is directed towards the dichroic mirror 109C through the light collecting unit 111C and collimator 112C. Thus, the dichroic mirror 109C receives the green, the red and the blue beams and directs them to the mirror 109D, in transmission mode for green, red beams and reflection mode for the blue beam.

The combined light is reflected by mirror 109D towards a de-speckling unit 110 and a beam shaping unit 113. Light output from the beam shaping unit preferably passes through a condenser lens 115, and also preferably passes a lens unit 116 (the configuration and operation of which will be described further below). Further optionally provided in the projection display are a field lens 420 and a polarizer 902 located upstream of a transmissive SLM 104. Output light spatially modulated by the SLM passes through an analyzer 904 and then through a projection lens 106, providing a necessary magnification scale on the screen. It should be noted that the order of the light sources and the dichroic mirrors can be changed and the SLM may include polarization optics such that polarizer, analyzer and, optionally, a compensating phase retarder.

Also, the use of a polarization optics unit is generally optional, and such unit may be used as a separate unit, or may be part of the illumination system 102 and/or the SLM system 104.

It should be noted that although a transmitting-type SLM is shown in the examples of the invention, the invention can be used with a reflective-type LCOS or a DMD device as well.

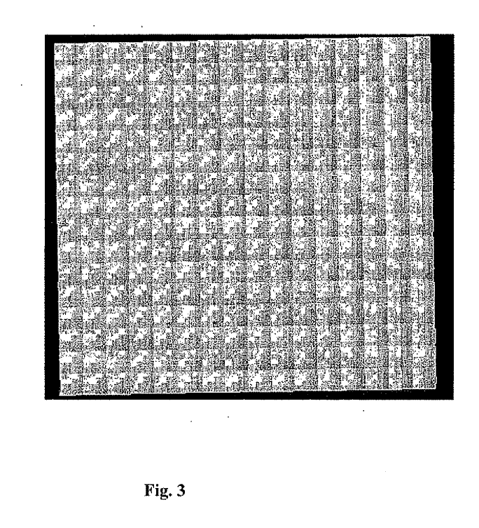

The beam shaping unit 113 may be configured as a dual micro-lens array (DMLA), namely a substrate having opposite surfaces thereof patterned to define two coaligned lenslet arrays. FIG. 3 shows one of the DMLA's surfaces comprising a rectangular shaped matrix of micro-lenses (lenslets). The F-number (F#) of each micro-lens in vertical or horizontal directions is the ratio between the micro-lens focal length and its height or width. The numerical aperture NA of the lenslet of the DMLA is defined as the sine of the half angle subtended by the lenslet, i.e. an angle to a half of the lens aperture, when viewed from the focal point. The NA may be approximately defined as ½F#. The NA of the lenslet characterizes the half collecting angle of the DMLA without cross-talks with adjacent lenslets. The NA might be different in vertical and horizontal directions, because of the rectangular shape of the DMLA lenslet.

The DMLA arrangement comprises two coaligned arrays sets of micro-lenses (MLA), front and rear, and is configured to provide desired uniformity and degree of collimation for the light to be incident onto the SLM. Each lenslet of the DMLA preferably has a rectangular cross section with an aspect ratio corresponding to the aspect ratio of the SLM active surface.

According to the invention, the de-speckling unit 110 includes a light diffusing surface 110A which is configured to provide light scattering effect randomly varying in time and space, as will be described more specifically further below. The inventors have also found that placing a light diffusing element upstream of a DMLA enables to further reduce any unwanted granular and speckle structure of the projected image on the screen from the diffuser. The granular and speckle structure is further reduced in such a configuration due to the overlapping effect of the rectangular spots of light created on the SLM by different DMLA lenslets, each having rectangular form.

In order to avoid light loss by the diffuser of the de-speckling unit, a proper combination of the DMLA parameters, diffusing angles and illumination angle of light sources should be brought into a match. The light emerging from the laser sources is in the form of a highly collimated beam, having a very low residue divergence angle θ_{source}. The diffuser of the de-specking unit has its diffusing angle θ_{diff} and the light emerging from the de-specking unit has a divergence angle approximately estimated as θₘₐₓ=θ_{source}+θ_{diff} (Root mean square sum). In order to avoid light loss in each of vertical and horizontal directions of the DMLA, the following condition has to be satisfied: NA>sin(θₘₐₓ/2), where θₘₐₓ is a maximum angle of the ray bundle emerging from the de-specking unit. The value of the maximum angle θₘₐₓ should therefore be below the limit of 2 arc sin (NA). On the other hand, closer the angle value θₘₐₓ to that of the numerical aperture NA, better the pupil fill and higher the image quality.

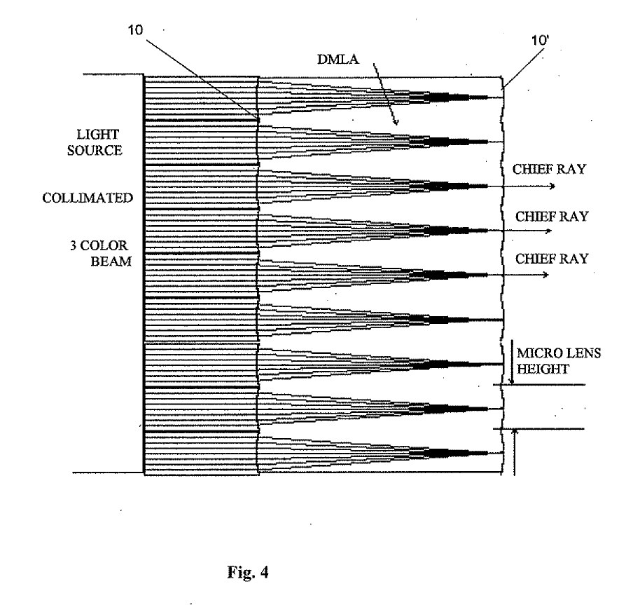

Reference is made to FIG. 4 illustrating a light beam propagation scheme through the DMLA. As shown, every lenslet of the front MLA 10 creates a separate focused beam on the rear MLA 10′ which outputs a respective parallel beam. The thickness of the DMLA is thus chosen such that the focus of the front MLA 10 is positioned exactly on the surface of the rear MLA 10′. The latter serves as an array of field lenses, correcting the chief propagation direction of each beam.

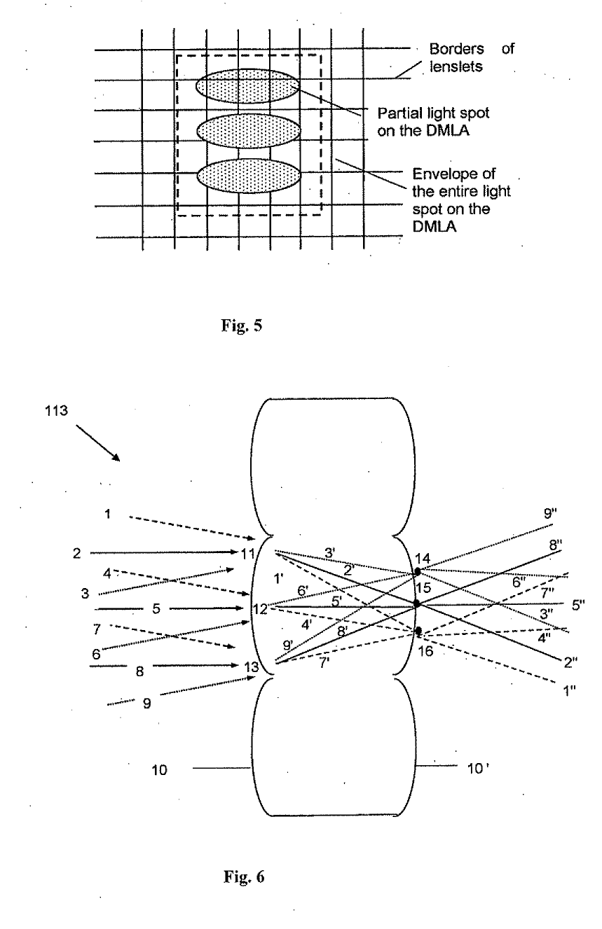

Reference is made to FIG. 5 illustrating a spot of light incident on the DMLA surface. A grid composed of horizontal and vertical lines shows the borders of the lenslets on the front side of the micro-lens array. The shaded circles show footprints (projections) of three light spots incident onto the DMLA from three different light sources. In order to get small angles of incidence in a highly collimated light beam reaching the SLM and also to enable small projector dimensions (i.e. short optical path), a small cross-section (diameter) of the beam on the DMLA is required. Also, a small diameter of the beam allows for minimizing the dimension (diameter) of the diffuser of the de-specking unit. However, decreasing the spot size on the DMLA results in a reduced number of lenslets covered by the beam spot size and, accordingly, provides less uniformity of the light intensity on the SLM. Specifically, the spot uniformity on the SLM might be poor when the beam diameter is smaller than 4-5 pitches of the lens arrays of the DMLA. Thus, increasing the light spot on the beam shaping unit provides higher uniformity. However, on the other hand, increasing the light spot on the beam shaping unit would require longer condenser focal length, which would affect the entire projection display dimensions at given SLM illumination angles. The light spot on the beam shaping unit is preferably such that an optimal compromise between uniformity and system compactness is achieved, being for example in a range of 1-5 mm. Another design parameter of the DMLA which is to be taken into consideration is an MLA pitch. For a given spot dimension, a smaller MLA pitch provides a larger number of the lenslets covered by the spot, but may result in the light power losses on “dead zones” in between the lenslets of the MLA. It should be noted that the dead zones are the narrow strips located between the borders of the MLA, resulting from the MLA fabrication process and providing improper optical performance. Smaller MLA pitch might also provide undesirable diffraction effects on the edges of the MLA lenslets. An example of suitable design for the projector is a light spot covering from 5 up to 100 lenslets, for the MLA pitch in the interval of 50 μm up to 1000 μm. Reference is made to FIG. 6 illustrating details of a light beam propagation scheme inside a DMLA 113 made of optical material (such as glass, plastic, crystal, sol-gel, etc), confined between front 10 and rear 10′ MLA arrays. Each of the front and rear surfaces 10 and 10′ is formed by lenslets. Incident light beam impinges on spaced-apart points 11, 12, 13 of the DMLA 113 at different incident angles. For focusing properties concerns, all the incident rays are considered with respect to their directions, irrespectively of their lateral position. In particular, normal incident rays (parallel to the optical axis) 2, 5, 8, lower boundary rays 3, 6, 9 and upper boundary rays 1, 4, 7 of the incident beam are depicted in solid, dotted and dashed lines in the figure. The front surface 10 of the DMLA 113 provides a beam focusing effect so that parallel ray bundles 2, 5, 8; 3, 6, 9 and 1, 4, 7 are transformed to the spherical ray bundles 2′, 5′, 8′; 3′,6′,9′ and 1′, 4′, 7′. It should be noted that, after passing the front MLA surface, the central rays of each spherical bundle (5′, 6′, 4′) are in oblique position with respect to the optical axis. In order to correct the oblique positions of the central rays, light beams are further transformed by the rear MLA surface 10′. The DMLA is configured such that convergence points 14, 15, 16 of parallel incident rays are located exactly on the rear surface 10′ of the DMLA. Specifically, focal point 15 of normal incident ray bundle is located at the center of the lenslet at the surface 10′, whereas convergence points 14 and 16 of oblique parallel incident ray bundle are located at the edge of the lenslet at the surface 10′, the latter then acting like a field lens. Accordingly the spherical ray bundles 2′,5′,8′; 3′,6′,9′ and 1′, 4′, 7′ are transformed to spherical ray bundles 2″,5″,8″; 1″,4″,7″ and 3″, 6″,9″, each having central rays being parallel to the optical axis, as depicted by solid lines, dotted lines and dashed lines. Such central rays parallel to the optical axis provide an optimal available collimation of the beam shaped by the DMLA to a uniform spot of light (rectangle).

Turning back to FIG. 2, it should be noted that the beam shaping unit 113 may be operable as a fly's eye integrator comprising a DMLA and a focusing condenser lens 115. The resulting intensity at the SLM plane is the superposition of the scaled intensities on the lenslets at the input side of the DMLA:

$${I}_{D} ( x , y ) \sim {\sum }_{i = 1}^{M} {\sum }_{j = 1}^{N} {I}_{ij} ( kx , ky )$$

where i, j is the lenslet number and k is the scaling coefficient between dimensions of the DMLA lenslet and dimensions of the SLM, M,N are the number of lenslets, in x and y directions, of the DMLA covered by a light spot. Larger the number of the lenslets covered by the beam, better the uniformity at the SLM plane. The fly's eye integrator does not increase the geometrical extent of the illumination beam over a size provided by a single lenslet, if the DMLA is illuminated by a telecentric beam with a divergence 2ω_{DMLA}<dₗₗ/fₗₗ, when dₗₗ and fₗₗ are the size and the focal length of the lenslet.

The condenser lens 115 may be configured as a single-group or as a split lens, while placing the field lens 420 near the SLM. This configuration provides a telecentric illumination of the SLM and may perform optimal matching between the illumination and projection pupils, if adding one more field lens is added between the SLM and the projection lens, since the regular projection lens has its entrance pupil inside it. In case of LCoS SLM, the field lens operates in both illumination and projection paths, providing both telecentric illumination of the SLM and pupil matching.

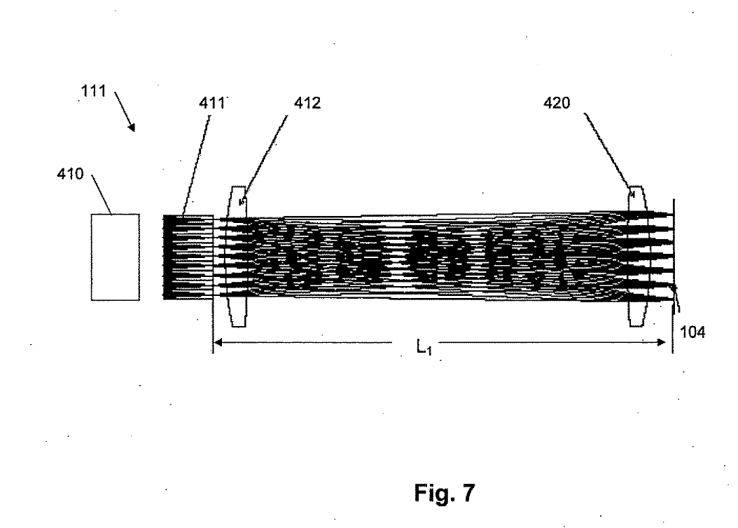

Reference is made to FIG. 7 showing an example of a partial view of a DMLA illumination unit of a projection display of the present invention with fly's eye integrator. In this specific example, the SLM system 104 is a transmitting LCD panel, but the invention is equally applicable to LCOS and DMD panels. The DMLA 411 collects and shapes the beam emerging from the de-specking unit 410. Further transformation and relay of light may be performed by a condenser lens 412 and a field lens 420. For the projector configuration, the condenser lens 412, in this embodiment, is preferably configured as a simple double convex positive lens with an effective focal length (EFL) approximately equal to its back focal length. Accordingly, the field lens 420, in this embodiment, is preferably configured as a simple double convex positive lens with EFL approximately equal to its back focal length which is identical to that of the condenser lens 412. The lenses 412 and 420 are required together for achieving proper collection of light from the DMLA 411 and imaging the DMLA 411 as a uniform rectangular spot of light on the SLM system 104. Moreover, the lenses 412 and 420 reduce the angular range of the illumination light, since contrast ratio of LCD (or LCOS or DMD) panels is improved with smaller angles, leading to long focal length lenses. The light beam after the DMLA 411 passes through the condenser lens 412 which collects rays from all micro-lenses of the DMLA 411 and directs all the chief rays to be focused at the center of the SLM (LCD Panel) 104. Thus, lens 412 provides a full and uniform overlap of rectangular light spots from all the DMLA lenslets resulting in the creation of a rectangular spot on the SLM active surface formed by light rays from all the lenslets. This actually presents an effect of averaging of multiple light components, thus further reducing the speckle effect. The field lens 420 corrects the direction of a ray bundle incident onto each SLM point. The dimension of the rectangular spot on the SLM active surface is equal to the product of the DMLA field of view

$$2 ω \approx \frac{d}{f} ,$$

when d is the microlens dimension in the corresponding direction and f is the lenslet focal length, by condenser focal length. The maximum angle, in radians, of the light rays incident onto the SLM active surface is the ratio of the spot size on the DMLA to the condenser focal length. It should be noted that the SLM 104 is in focus of the condenser lens 412 and accordingly the total track, i.e. mechanical extent, of the illuminating optics arrangement of FIG. 7 is essentially the same as the focal length of the condenser lens.

Turning back to FIG. 1B, it should be noted that the illumination system 102 may provide a single illumination beam comprising the light portions of multiple wavelengths propagating, towards a common SLM (as exemplified in FIG. 2). Alternatively or additionally the illumination system 102 may be configured for producing and combining coherent (laser) and/or incoherent (LED type) light sources such that each light source channel has its own SLM unit or two or more light channels are associated with a common SLM. Thus, light from laser sources may pass through all the elements of the illumination system 102 (thus undergoing de-speckling and shaping processing), whereas light from LED sources proceeds to the successive blocks of the system, and do not go through as shown by the dashed arrow in FIG. 1B.

The projection display of the present invention thus enables the use of combination of LED(s) and laser(s). The light source unit 108 may comprise two laser sources (e.g. of red and green primary colors) and a LED (e.g. of blue primary color), producing three light beams of different wavelengths. The use of red and green lasers enables low power consumption illumination for the projection display 100, and the use of a blue LED is preferred in order to avoid the high cost of the currently available blue lasers. Other combination of lasers and LEDs may be used, such as: (a) red and blue laser and green LED; and (b) green laser with blue and red LEDs. Alternatively, the light source unit 108 may comprise three laser sources (e.g. of red, green and blue primary colors).

As indicated above, the provision of a de-speckling unit is associated with the operation with coherent light (laser source). The de-speckling unit 110 is configured and operable to scatter light impinging thereon with a full diffusing angle of less than an upper limit θ which may be defined in an interval from 0.1 up to 10 degrees. As indicated above, placing a light diffusing element in the projection display might give rise to unwanted granular structure of the projected image on the screen. This granular structure is coarser than speckle but might reduce substantially the image quality. In order to avoid granular structure and substantially reduce the speckle effect, the light scattering element is preferably placed in the optical path between the light source and the beam shaping unit, at some small distance from the beam shaping unit so as to avoid imaging of the scattering surface of the light scattering element onto the DMLA. The inventors of the present application have proved experimentally that placing the diffuser before the DMLA indeed provides substantial reduction of speckles without additional granular structure. As indicated above, the de-speckling unit is configured and operable to provide a scattering effect randomly varying in time and space. To this end, the de-speckling unit is configured as a continuously displaceable diffuser (scattering surface) which may have different configurations in mechanical shape and motion type. The de-speckling unit may include at least one of the following: a voice-coil diffuser, a rotationally vibrating diffuser, a rotating disc diffuser, and a tubular rotating diffuser, or a MEMS activated diffuser. Additionally, electro-optical implementation of a displaceable diffuser like diffusing liquid crystal panel or acousto-optical modulator is possible in another embodiment of the invention.

Each position of the diffuser creates a speckle pattern at the observer eye, while its contrast depends on the coherence of the laser beam and parameters of the entire optical system. While moving, the diffuser creates various non-correlated speckle patterns, which are averaged by eye through its averaging (perception) time (˜0.1s).

Reference is made to FIG. 8 showing a general mechanical layout of a voice coil vibrating diffuser unit comprising a light scattering surface 3 and a displacement mechanism therefore including a coil 1 and a magnet 2, all being mounted on a holding frame 4. One of the advantages of using a voice coil is in its compactness.

The diffuser may perform a linear movement. By applying an AC current on the coil at different frequencies and different amplitudes, periodic linear movements are created. The linear vibration can be achieved with minimum electrical power when applying the AC current at the same frequency corresponding to the natural resonance frequency of the mechanical structure.

Reference is made to FIG. 9 showing a general mechanical layout of a rotationally vibrating diffuser. The vibrating diffuser comprises a light scattering surface 3 driven by a DC motor 1 mounted on a motor holder 2. The DC motor is driven by an AC current. The diffuser 3 is rotated by the motor at a small angle back and forth around its axis, in a periodically changing direction.

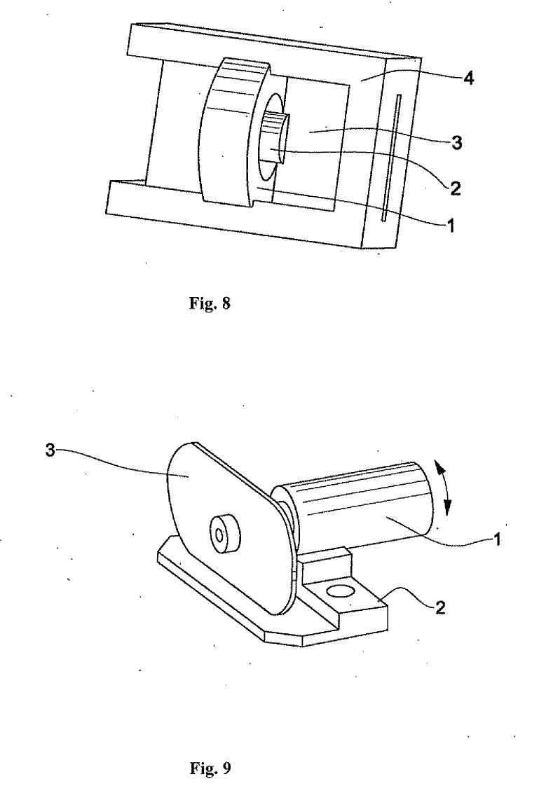

Reference is made to FIG. 10 showing a general mechanical layout of a rotating diffuser unit comprising a disc 1 made of a diffusing material defining a light scattering surface 3 attached to an electrical motor 2. The latter operates to provide a continuous rotation of the scattering surface 3. A light spot 4 is incident on the periphery of the disk. Therefore the clear aperture of the scattering surface preferably have a circular shape having dimension of at least twice the light beam cross section, wherein only a peripheral (ring-like shaped) part of the disc is optically used. The dimensions of the clear aperture of the rotating diffuser are preferably minimized by optical reduction (focusing) of the cross section 4 of the light beam on the rotating diffuser. The rotating diffuser features low power consumption, high available rotation speed, low noise and consequently efficient speckle reduction.

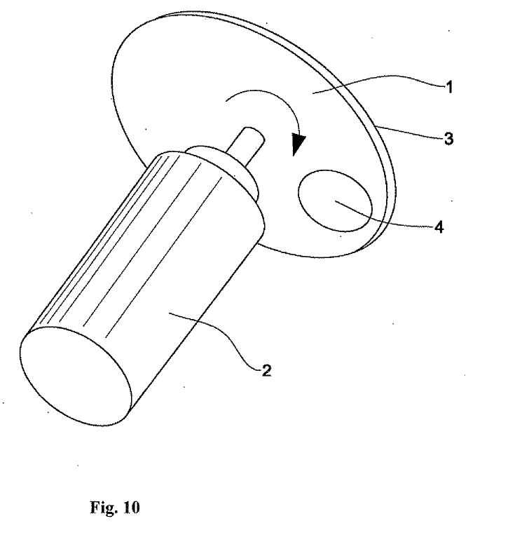

Reference is made to FIGS. 11A-11B showing yet another example of a general mechanical layout of a rotating diffuser 1. In this specific example, the tubular diffuser is shown shaped as a cylinder and having a surface (e.g. inner, outer or both) made as a light scattering surface, e.g. a surface formed with light diffusing grooves. The cylinder is mounted for rotation on an electrical motor 3 connected to a power supply e.g. by a flexible cable 2 via a connector 4. The motor 3 operates to provide continuous rotation of the cylinder. The cylinder of the tubular diffuser 1 is assembled perpendicular to the optical axis of light propagation, as seen in FIG. 11B. The light scattering surface (e.g. light diffusing grooves) of the tubular diffuser 1 may be fabricated directly on the inner, outer or both cylindrical surfaces. Alternatively, a flexible plastic sheet having light diffusing grooves may be placed into the cylinder, by attaching the opposite edges of the sheet. In order to compensate for the effect of light diffusing on the attached edges, a random change of the motor rotation speed may be applied by changing its driving voltage in a random manner. The tubular diffuser provides the same linear speed at all the parts of the cross-section of the light beam. The tubular diffuser configuration is compact both in width and height and feature power saving due to the continuous manner of rotation. Moreover, the beam, while propagating along an axis substantially perpendicular to the cylindrical axis (or generally inclined with respect to the cylindrical axis), passes twice through the diffuser thus improving the speckle reduction.

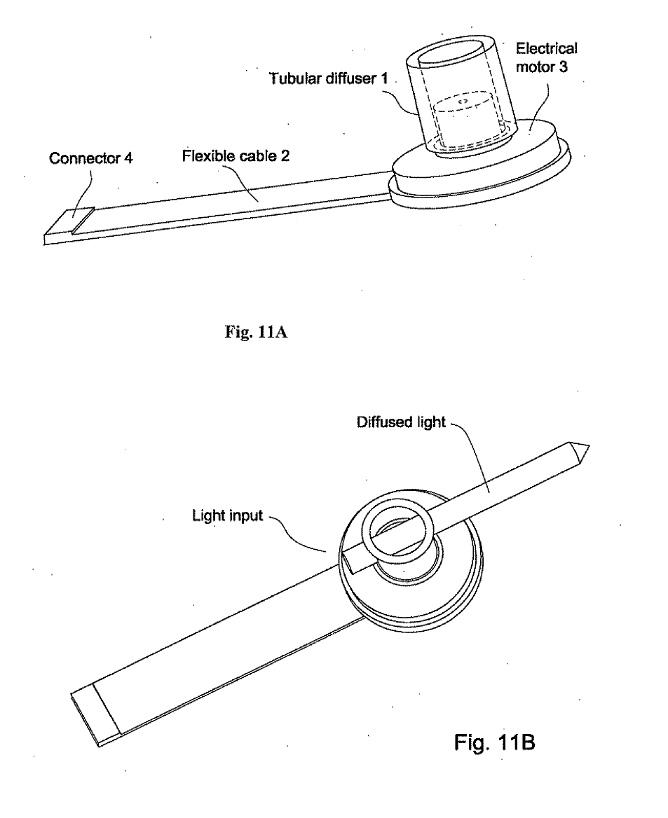

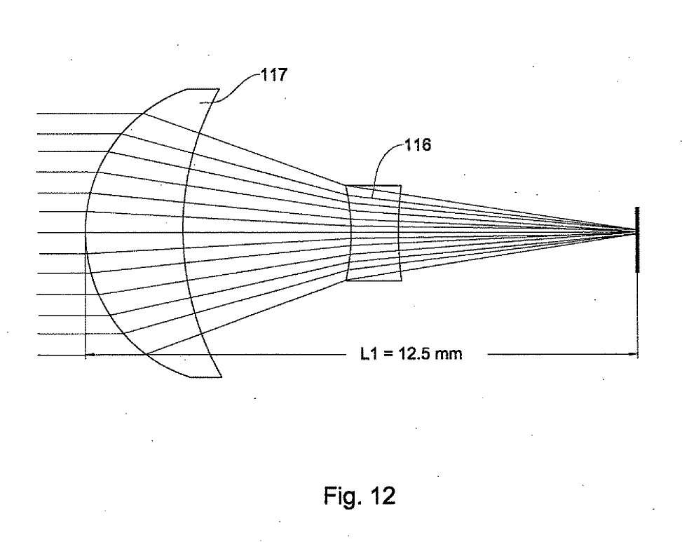

As indicated above with reference to lens unit 116 in FIG. 2, the optical path of light within the projection display device may be reduced by using a telephoto principle (i.e. the use of a combination of a positive and negative lens) in the illumination channel, by adding a negative lens 116. In this connection, reference is made to FIG. 12, illustrating more specifically the telephoto principle in which the total track of an optical system is reduced while the effective focal length (EFL) is maintained. In this specific example, a telephoto combination of positive and negative lenses (117 and 116) having the same EFL of 20 mm is used. The total track of the optical system is 12.5 mm, which is substantially smaller than the EFL.

In the present invention, the telephoto principle is applied to the illumination system, with a benefit of a smaller total track, mechanical dimensions, volume and lighter weight of the illumination system and of the entire projector display. It should be noted that a trade-off exists between the degree of beam collimation at the SLM plane and the total track of the system, dependent on the focal lengths of the condenser and the field lenses. The shorter focal lengths and distances of the optical track are useful for the minimization of the mechanical dimensions of the projector display. On the contrary, the longer focal lengths and distances are preferable for achieving low residue divergence angles of the collimated illumination beam incident onto the SLM. In order to reduce an impact of the described trade-off, the telephoto principle can be used. A negative lens is added between the condenser lens and the field lens in the illumination system, for the sake of enabling uniform intensity and highly collimated illumination with a relatively short optical total track of the illumination system.

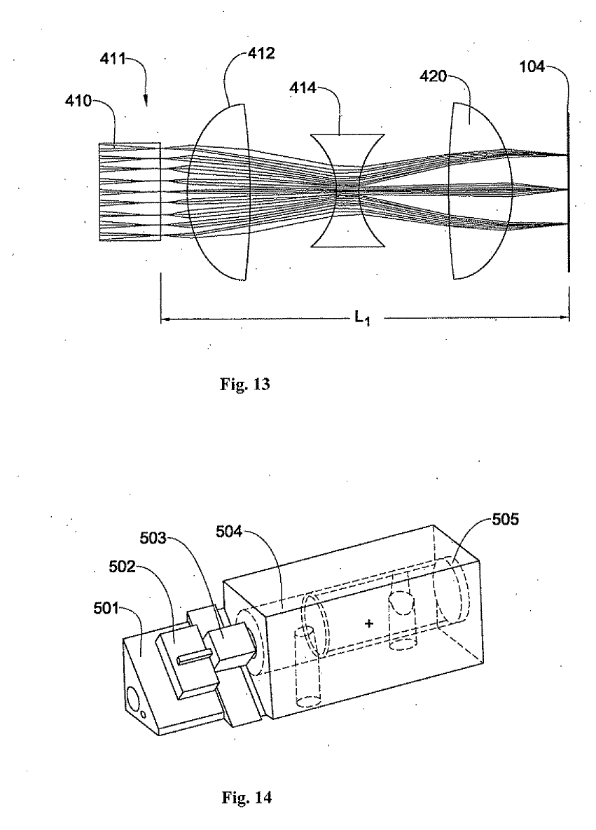

In this connection, reference is made to FIG. 13 showing a telephoto optical arrangement associated with a DMLA and a transmissive LCD panel. The DMLA 411 collects and shapes the beam emerging from the de-specking unit 410. Further transformation and relay of light is performed by a positive condenser lens (e.g. double convex aspherical) 412, negative lens (e.g. double concave spherical) 414 and a field lens 420. Therefore the telephoto concept makes use of one additional negative lens 414 and enables a significant reduction of the total track of the illumination system. Comparing the configuration of FIG. 13 to that of FIG. 7, the length L₁ of the telephoto illumination system of FIG. 13 is shorter by 37% than in the illumination system represented in FIG. 7.

In other embodiments, the telephoto optical arrangement may be associated with a DMLA and a reflective SLM (e.g. LCOS panel). In this case a beam splitter/combiner, typically a polarization beam splitter (PBS) element, has to be added at the input of the SLM. A field lens may be placed in between the PBS and the SLM.

In some embodiments, the light source, the diffuser and the DMLA are configured and operate together so that the dimension of the cross-section of the light spot on the diffuser is smaller than the dimension of the SLM active surface (i.e. the diagonal dimension of the aperture at the SLM active surface). It should be noted that the SLM active surface refers to the surface of the SLM unit formed by an SLM pixel arrangement, and is the internal surface of the SLM unit being enclosed between substrates (e.g. glass) and appropriate spacers. Such pixel arrangement comprises a two-dimensional array of active cells (e.g. liquid crystal cells), each serving as a pixel of the image and restricted by an opaque SLM aperture. In a non-limiting example, the cross-section of the light spot on the diffuser may be in the range of 1 mm up to 5 mm, then the diameter of the diffuser, which is about twice the size of the light spot, is still compatible with a compact projection display. The diffuser is preferably configured as a surface relief diffuser with a full light diffusing angle in the range from 0.1° up to 5°.

Returning to the details of the light sources, the illumination system of the projection display comprises red, green and blue light sources which include lasers and/or LEDs. The use of the projector display of the present invention as a compact device imposes quite tough requirements on RGB (red, green, blue) light sources: relatively high power light output of several hundreds mW at each of RGB wavelengths; operation temperature of less than 50° C. without active cooling; high optical efficiency; low beam geometric extent; potential for top-hat beam shaping with limited illumination angular range; low costs in mass production. Reference is made to FIG. 14 exemplifying partially a green light channel configuration including a diode pumped solid state (DPSS) laser, mechanically assembled with a beam expander, which serves both as a light collecting unit and a collimator. It should be noted that the beam expander enables to provide a green beam diameter approximately equal or close to the size of the red and blue beams at their fast axis. The DPSS laser unit includes a triangular holder 501, a Pumping Laser Diode 502 (LD), an assembly of nonlinear crystals 503, and a beam expander 504-505. The triangular holder 501 serves as a heat sink, having mass, material and structure designed for optimal heat dissipating performance in ambient projector operation temperature range (OTR) of 25°-50° C. The pumping LD 502 which may be associated with an optional build-in thermistor is designed to emit radiation of wavelength in the range of about 807-809 nanometers at a working temperature of about 40°-50° C. typical for the device. The LD may be attached to the triangular holder 501 with a thermal heat conducting glue. Electronics/drivers of the LD may control the driving current and duty cycle used for emitting the radiation within the time frame of the mobile projector device. The LD is preferably attached to an optical contact, for example with a UV glue, to an assembly of nonlinear crystals. The assembly of nonlinear crystals 503 may include a frequency conversion crystal, preferably Nd:YVO4, and a frequency doubling (lasing) crystal, preferably KTP, which emits polarized laser light with a wavelength of 532 nanometers and a diameter of, for example, 70-200 micrometers. The assembly of the nonlinear crystals is preferably mechanically attached to the housing of the beam expander. The beam expander may be made of negative and positive lenses having effective focal lengths EFL1, EFL2 respectively and, accordingly, an expansion ratio of (EFL2/EFL1). The beam expander converts the narrow laser beam into an expanded and collimated green beam with the diameter of for example 1-5 millimeters at the wavelength of about 532 nanometers.

In some embodiments, the beam expander comprises, a first lens 504 (e.g. bi-concave rod) and a second lens 505.

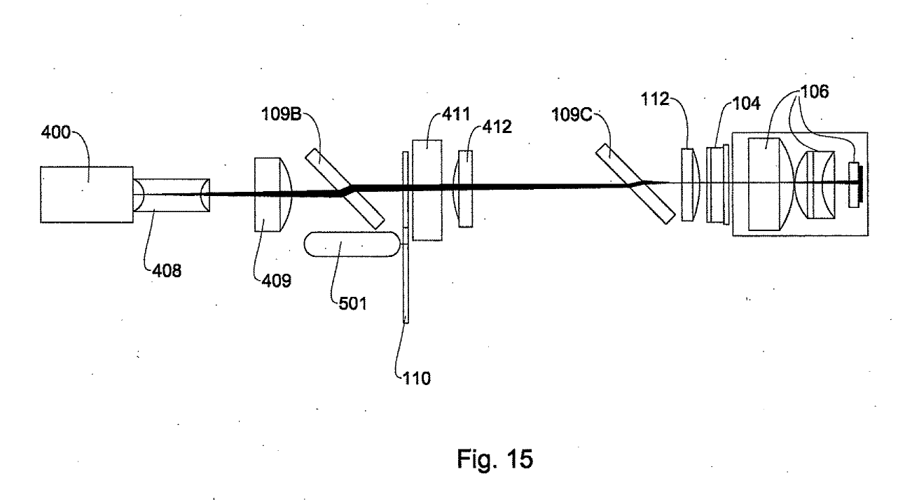

Reference is made to FIG. 15 illustrating an example of the green illumination channel. In this specific example, the green illumination channel comprises a DPSS laser unit 400, a beam expander formed by a bi-concave negative lens 408 and a collimator positive lens 409; a rotating electrical motor 501 to rotate the rotating disc diffuser 110 operating as the de-speckling unit; a dichroic mirror 109B which transmits green and reflects red light; a DMLA 411; a condenser lens 412; a dichroic mirror 109C which transmits green and red light and reflects blue light; a collimator lens 112. The so combined light impinges onto an LCD panel 104 and modulated light propagate to a projection lens 106.

It should be noted that the implementation of laser light sources with visible wavelengths suitable for portable projection displays meets several technological problems, related with severe limitations in size, power dissipation, optical to electrical efficiency and high and variable operation temperature. A typical situation is that available lasers provide very limited output powers, of few tens of mW, which is not enough for a mobile projector display system requiring about 10-50 lumen of light flux on the screen.

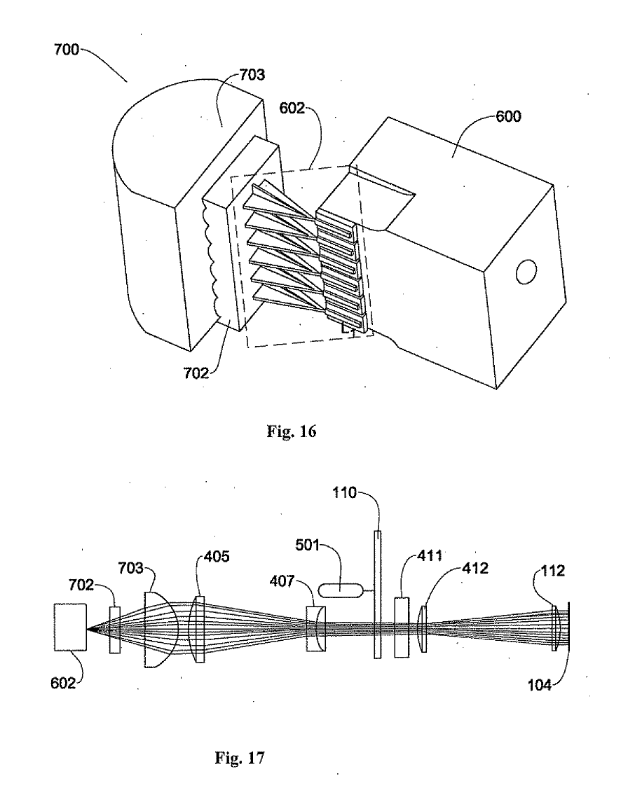

According to one aspect of the present invention, a set of several lasers is combined into an array on the packaging level, to meet temperature stability, heat dissipation and lasing power requirements. Reference is made to FIG. 16 representing a laser array light source 700 associated with a collecting unit and collimators, such that a plurality of beams are combined into one essentially collimated beam. The light source 700 comprises a laser diode array 600 which is provided on the base of packaging of several lasers, for an efficient passive thermal management, and in an assembly with first slow and then fast axis collimation optics. In this non-limiting example, the laser array 600 contains six laser diodes 602 assembled with a pitch of 1 mm, such that all the emitters are disposed in line. Whereas the entire array 600 has a relatively large total spatial extent of few millimeters, each laser has a small, few micrometers, emitter size and, accordingly, is efficiently collimated with a low residue divergence. Therefore, the laser-array 600 features low etendue (i.e. squared product of the beam geometric extent over the beam divergence) and multiple output power, which is an important requirement for the development of the projector display system of the present invention. The collimation of the laser-array 600 is achieved using a crossed cylindrical micro-lens array to enable individual addressing of each of the lasers. It should be noted that the crossed cylindrical micro-lens array generally defines a first array of cylindrical micro-lenses extending in one direction and a second array of cylindrical micro-lenses located downstream of the first array, extending in perpendicular direction. The focal length of the two arrays may be different and match slow and fast axis divergence of the laser diode.

It should be noted that a standard approach for laser bar collimation module is to collimate first the fast axis with aspherical cylindrical lens and then the slow axis with a lenticular array of cylindrical lenses. The resulting collimated beam demonstrates an elongated linear structure built of several small spots. However, this approach does not fit the compact projector requirements. The collimator requirements are to perform the following with a reasonable number of optical components: collimate the beam of each and every laser in the array; and to create a spot with a few millimeter width, both in the x and y directions.

Reference is made to FIG. 17, illustrating an illumination channel with a diode laser array comprising a lenticular micro-lens array 702 for slow axis collimation and a cylindrical lens 703 for fast axis collimation, both axes having the common focal plane coinciding with the emitter plane of respective light sources—laser diodes in the present example. The fast axis of each of the laser diodes first diverges naturally the beam until the spot size reaches the entire size of the laser array, (e.g. 3-6 mm). Accordingly, the slow axis diverges up to the array pitch of about 1 mm, to avoid overlap of different laser beams in the array. The production of such collimator is possible by using the conventional molding techniques. The simulations and measurements show that the angular divergence of the entire beam from the red diode laser-array 600 projected onto the 0.25″ SLM does not exceed ±4° and the light collection efficiency is in the range of 75-85%. Also, a beam reducer unit is added for matching the large spot of the collimated output beam after the laser array with the smaller optimal light spot sized required on the de-speckling unit and the DMLA. The beam reducer use an inverted Galileo type telescope which comprises a positive lens 405 and a negative lens 407, which maintains the collimation but reduces the outer beam size. The Galileo type beam reducer can comprise positive and negative lenses or alternatively two positive lenses.

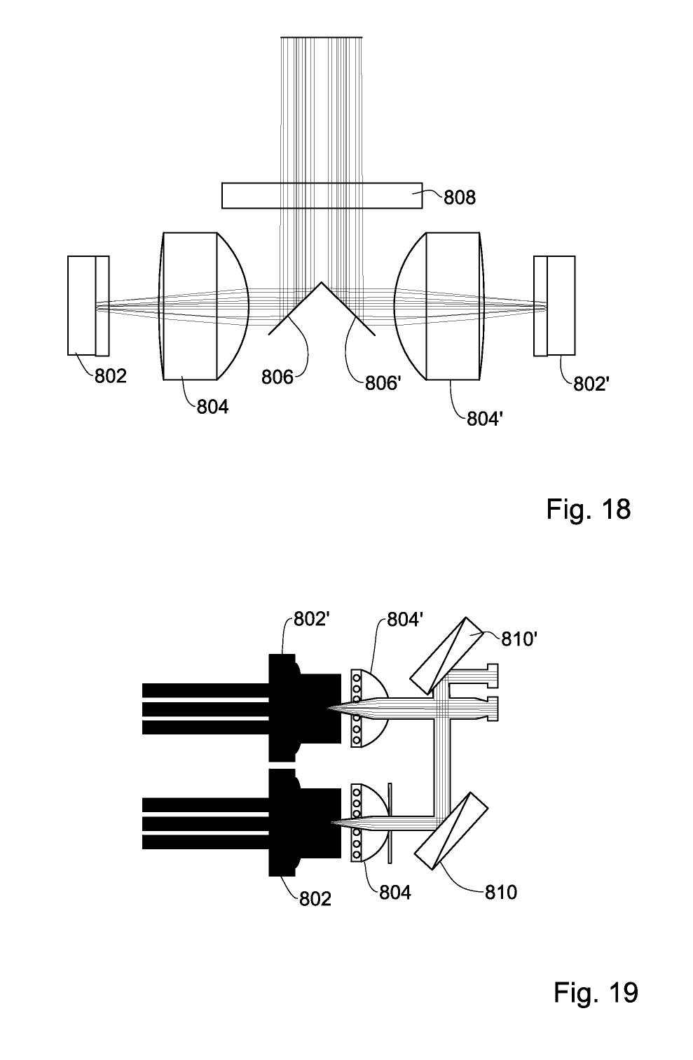

Reference is made to FIG. 18, illustrating another embodiment of the laser source comprising a pair of laser diodes, featuring an enhanced power output, and a beam combiner based on a reflective facet structure. The beam of each of the two separate laser diodes is collimated and directed to propagate at adjacent and parallel light paths by the means of reflection from two 45° facets with reflecting coatings. Specifically, light beams of the lasers 802 and 802′ are collimated by singlet aspherical lenses 804 and 804′, reflected by two mirror facets 806 and 806′ and pass through an optional polarization rotator 808, configured as half wave plate with the axis at 45° to the polarization of the lasers. The mirror facets 806 and 806′ might be produced as prism of glass of plastic material and then coated by aluminum, silver, chrome or another highly reflective coating, optimized for reflection coefficient in the red region of light spectrum.

Reference is made to FIG. 19, illustrating another embodiment of the laser source comprising a pair of laser diodes with enhanced power output and a beam combiner based on a reflective periscope. The beam of each of the two separate laser diodes is collimated and brought to propagate at adjacent and parallel light paths by the means of reflection from two mirrors oriented with a 45° tilt. Specifically, light beams of the laser diodes 802 and 802′ are collimated by lenses 804 and 804′, reflected by two mirrors 810 and 810′ and then propagate on the parallel light paths with a small lateral shift. The mirrors 810 and 810′ might be made of glass of plastic material and then coated by aluminum, silver, chrome or another highly reflective coating, optimized for reflection coefficient in the red region of light spectrum

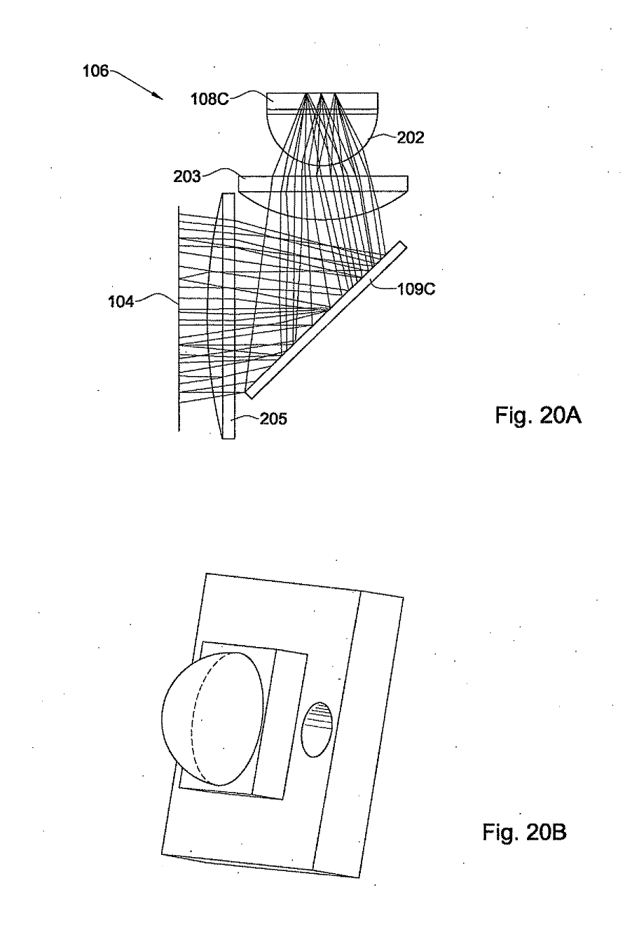

Reference is made to FIGS. 20A and 20B, representing a single high-power LED type light channel (for example blue light channel), configured according to the present invention. The LED (for example blue) light channel is different from laser (for example both the green and red) channels, since a LED is an extended source with a very high divergence of its radiation, i.e. with a large etendue (i.e. squared product of the beam geometric extent over the beam divergence). Accordingly, an efficient collection and collimation of the LED light is a challenging scientific and engineering task. Typically, the angle of a light beam emitted by a LED is reduced from ±90° degrees to about ±10° degrees, while the emitting LED area is transferred into essentially uniform rectangular light spot with few millimeter dimensions of the SLM active surface. The LED light channel may comprise an emitting surface 108C; a build-in collecting lens 202 (e.g. half ball) packaged with the LED; a collimator aspheric lens 203; and a further optical part common with one or more other channels. This optical part includes a dichroic mirror 109C which reflects LED light (for example blue) and transmits light of other primary (for example red and green) colors, and a SLM surface 104. The spot size and angles on the SLM surface may be determined by using a LED with a build-in lens 202 and two positive lenses 203 and 205. Since the LED emitter 108C is placed in the focal plane of the blue channel optical train, it is focused at the pupil of the projection lens, creating a uniform image at the image plane, even if the LED emitting surface 108C has non uniform patterns.

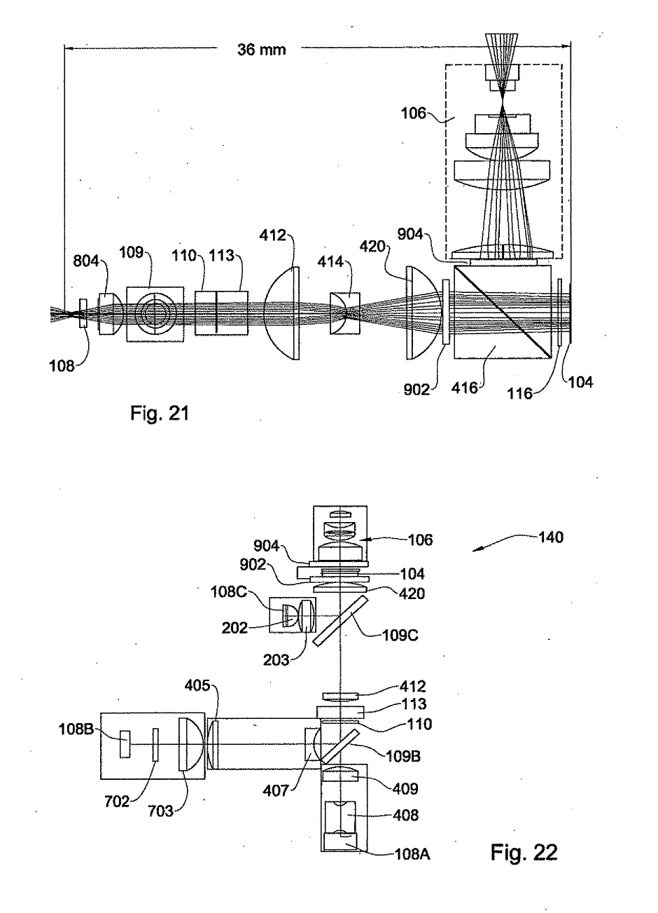

Reference is made to FIG. 21, illustrating a typical single-color laser channel of the projector display system associated with a LCOS-type SLM and an optional telephoto illumination channel. Other RGB or different color channels may be combined by a dichroic X-cube 109. The construction and operation of a dichroic X-tube are known to the skilled in the art and therefore need not be described in details. Light from a laser 108 is collimated by a collimator lens 804 (e.g. aspherical), pass through the X-cube beam combiner 109. The fully combined collimated red, green and blue beams pass through a de-speckling unit 110 and a beam shaping unit (preferably DMLA) 113, a condenser lens 412, an optional negative, preferably double concave, telephoto lens 116, a field lens 420, which together convert the light intensity distribution into a rectangular spot on the LCOS active surface. The condenser lens 412 and the field lens 420 may be identical aspherical lenses, and the negative telephoto lens 116 may be a plano concave lens, fabricated preferably of a high index glass. Light linearly polarized by a polarizer 902 further passes through a polarization beam splitting cube (PBS) 416 and a retarder or retarder stack 116 fabricated as a polarization waveplate, which change the polarization state of the incident light in order to improve the SLM reflection coefficient and contrast. The dimensions of the PBS cube are for example 7×7×7 mm. The output light reflected and spatially modulated in the polarization state by the LCOS SLM, passes backwards through the retarder 116 and is reflected from the PBS 416, passes through an analyzer 904 and imaged by an object telecentric projection lens 106, providing necessary magnification scale on the screen. The projection lens may comprise five spherical lenses having diameter up to 8 mm, corrects aberrations caused by the polarization beam splitting cube and features NA of 0.167 and the LCOS active surface of 3×4 mm. In this specific configuration, the total length of the projector is 36 mm. It should be noted that the order of the light sources and the dichroic mirrors can be exchanged and that the SLM may include additional polarization optics such as polarizer, analyzer and, optionally, a compensating phase retarder or a quarter wave plate.

Reference is made to FIG. 22, illustrating a specific but not limiting example of an LCD projection display system 140 associated with a combined laser and LED light source unit, wherein the red laser source is an array of six laser diodes. Specifically, the green and red light sources are of laser type and the blue source is of LED type. In this example, the green light source includes a green DPSS laser, the red light source 108B is in the form of a red laser diode array made of a plurality of elements (diodes), arranged with a pitch of 1 mm, and the blue light source 108C is configured as a blue LED. The green light source 108A comprises a green laser beam expander configured as a Galileo type containing a negative lens 408 and a positive lens 409. The laser diode array 108B is associated with a lens unit including a lenticular micro-lens array 702, e.g. an array of six cylindrical lenses; and a cylindrical lens 703 which is configured to collimate the fast axis of the laser diode array 108A.

In one embodiment of the present invention, an inverted telescope (405,407) which maintains the collimation but reduces the beam size on the DMLA, is used (as described above). Thus, the two laser beams propagate along a common optical path towards a de-speckling unit 110 and a DMLA 113, then pass through a condenser lens 412 and proceed towards a dichroic mirror 109C. The blue LED 108C may have a half ball light collecting lens 202 attached to its packaging case, and a collimator lens 203 for reducing divergent angles of the LED from 90° down to approximately 40° creating a spot with a diameter equal to the diagonal of the SLM active surface. The collimated green light beam emerging from the lens 409 is transmitted by the red dichroic mirror 109B. The collimated red light beam emerging from the lens 409 is reflected by the red dichroic mirror 109B. Therefore, the dichroic mirror 109B combines the green and the red beams in transmission and reflection modes. The combined light propagates along a common optical path towards de-speckling unit 110 and DMLA 113, then passes through a condenser lens 412 and proceed towards a dichroic mirror 109C. The latter reflects blue light and transmits green and red light thus producing fully combined red, green and blue beams propagating via the field lens 420 and polarizer 902 onto a transmissive SLM 104. The field lens 420 collimates the combined light, reducing an angle of incidence of light hitting the SLM 104 in order to improve the SLM transmission and contrast.

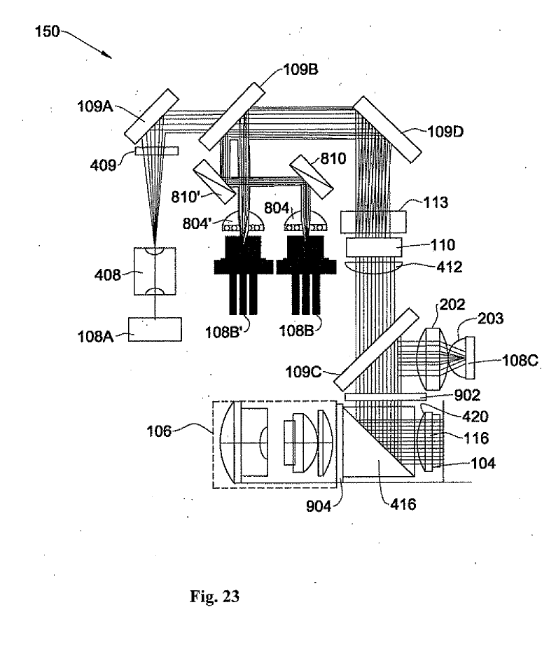

Reference is made to FIG. 23, illustrating a specific but not limiting example of a configuration of an LCOS projection display system 150 including a combined laser and LED light source unit, wherein the red laser source is configured as a pair of red lasers associated with a reflective periscope as illustrated in FIG. 19. Specifically, the green and red light sources are of laser type and the blue source is of LED type. In this example, the light source unit includes a green light source formed by a green laser, a red light source 10813 and 10813′ configured as a pair red laser diodes combined with a periscope optical arrangement, and a blue light source 108C configured as a blue LED. The green light source 108A comprises a green laser beam expander configured as a Galileo type containing a negative 408 and a positive 409 lenses. The light beams of the pair of the red lasers 108B and 108B′ are collimated by lenses 804 and 804′, reflected by two mirrors 810 and 810′ and then propagate on parallel light paths with a small lateral shift. The blue LED 108C has a light collecting lens 202 (e.g. half ball) attached to its packaging case, and a collimator lens 203 for reducing divergent angles of the LED from 90° down to 40° creating a spot with a diameter equal to the diagonal of the SLM active surface. The collimated green light beam emerging from the lens 409 reflects from the mirror 109A towards the red dichroic mirror 109B. The dichroic mirror 109B combines the green and the red beams in transmission and reflection modes and directs them to the mirror 109D. The mirror 109D reflects the combined collimated green and red light beams towards a de-speckling unit 110. The combined light propagates along a common optical path towards a de-speckling unit 110 and the DMLA 113, pass through a condenser lens 412 and proceed towards a dichroic mirror 109C. The dichroic mirror 109C reflects blue light and transmits green and red light and thus produces a fully combined collimated red, green and blue beams, which pass through a polarizer 902 and are reflected from a polarization beam splitting cube (PBS) 416 towards the field lens 420. The field lens 420 collimates the combined light, reducing an angle of incidence of light hitting a reflective LCOS 104. An optional retarder or retarder stack 116 fabricated as a polarization waveplate change the polarization state of the incident light in order to improve SLM reflection coefficient and contrast. The output light reflected and spatially modulated in polarization state by the SLM, passes backwards through the retarder 116, field lens 420, is transmitted through the PBS 416, passes through an analyzer 904 and imaged by the projection lens 106, providing necessary magnification scale on the screen.

It should be noted that typically laser diodes emit beams with substantially different divergence angles and elliptical cross section with different dimensions in fast and slow axes. The beams are usually collimated by collimating lenses (spherical or aspherical). In each of the fast and slow directions, the elliptical beam has the dimension D such that D=2f·NA, where f is the collimator focal length and NA is the collecting numerical aperture in the corresponding direction. The full divergence of the collimated beam is

$$2 ω \approx \frac{a}{f} ,$$

when a is the emitter size.

An aspect ratio (i.e. long-to-short axis ratio) of the elliptical beam spot of a collimated laser diode beam is in the range of 3:1 to 6:1. Therefore, the number of DMLA lenslets covered by the elliptical light spot at the DMLA may be insufficient, which might result in a low spatial uniformity at the SLM plane within the SLM active region. Since the minimal lenslet size is limited by MLA fabrication technology and fundamental diffraction phenomena, the short light spot size at the DMLA should exceed few times the lenslet dimension. On the other hand, the long light spot size with significant aspect ratio at the DMLA should have an upper limit due to small volume and compactness requirements of the projector display. Therefore, the laser beams should preferably be circulized i.e. provided an aspect ratio close to 1:1 before interacting with the DMLA. The present invention teaches several embodiments for the projection display system with circularization of elliptical laser diode beams, exploiting cylindrical lenses, prisms and special diffusers.

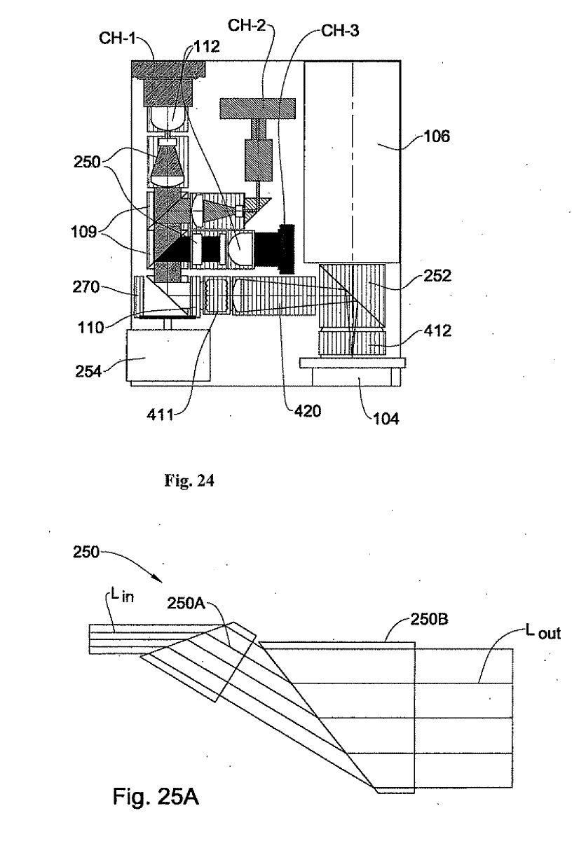

Reference is made to FIG. 24 illustrating a cross sectional view of an example of a configuration of the projection display of the present invention. Here, the projection display, in particular its illumination system comprises a beam circulizer exploiting cylindrical lenses. The illumination system is configured to define three light channels CH-1, CH-2 and CH-3 for the generation and propagation of red, green and blue light beams respectively. These light channels are then combined by a dichroic beam splitter/combiner 109. A combined light beam undergoes random scattering by a rotating disc 110 associated with its drive 254 and then passes through a beam shaping unit comprising a DMLA 411 and a condenser lens 420. The light output from the lens 420 is reflected by a PBS 252, passes through a further lens assembly including a field lens 412 and is then directed towards a reflective-type SLM 104. The modulated light is directed by PBS 252 to pass through a projection lens unit 106. In this example, two light channels CH-1 and CH-3 utilize collimators 112 at the output of the respective light sources and additional beam expander 250. This is associated with the fact that the light beams produced by these light sources have elliptic cross section. The elliptic beam may thus be pre-collimated by collimator lens 112 (e.g. axially symmetric) up to the fast axis size equal to the required beam diameter at the DMLA plane. Then, the collimated elliptical beam is circulized by a circulizer 250, for example configured as an inversed Kepler or Gallileo telescope 253 including cylindrical lenses.

The circulizer may include toroidal elements in place of cylindrical lenses, which allows reducing the total number of elements and a higher quality of circularization and collimation.

It should be noted that, as illustrated in FIG. 24, a diffuser with a rectangular far-field pattern may be used to optimize the pupil fill by using a diffuser 110 having a rotation axis perpendicular to the optical axis. Since the lenslets have a rectangular shape and the front MLA focuses the far-field of the diffuser onto the back MLA, the optimal far-field pattern of the diffuser has rectangular shape. Moreover, since the aperture stop of the illumination system is close to the DMLA, a better filling of the DMLA back surface improves the projector display image quality.

As indicated above, in this example, reflective type SLM 104 is used being equipped with PBS 252 used to illuminate the SLM display and transmit the light from the SLM to the projection lens 106. Dielectric thin film coated or wire grid PBS may be used in the proposed configurations.

A telecentric ray tracing may be directed towards the polarizing beam splitter (PBS), leading to a maximal contrast, but causing complication and size increase of the condenser and the projection lens. Alternatively, a non-telecentric ray tracing may be directed towards the PBS, leading to a simple and compact design, but lowering the contrast.

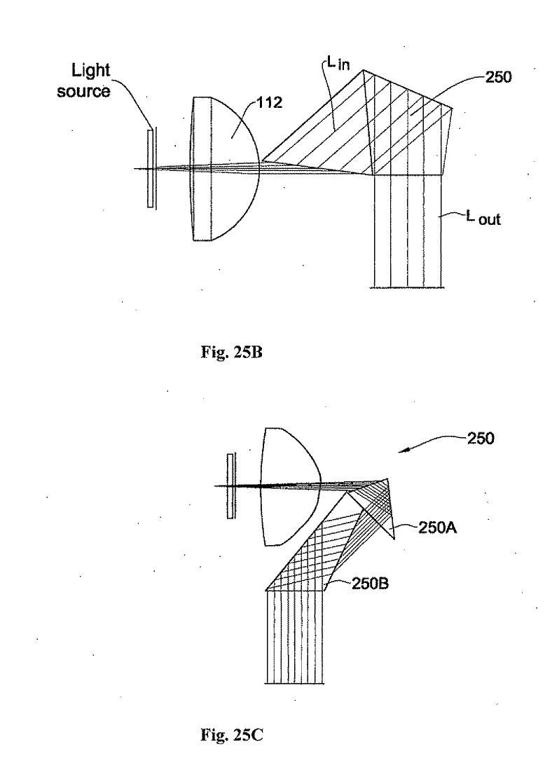

The circulizer may be configured as a prism circulizer which substantially changes the beam size in one of the directions, while does not change the beam size in a perpendicular direction. Three possible implementations of the prism circulizer are illustrated in FIGS. 25A-25C. In FIG. 25A, the circulizer 250 is in the form of two prisms 250A and 250B; when passing through prism 250A input light beam Lᵢₙ undergoes expanding along the vertical axis while being redirected from its initial direction, and the light passage through prism 250B results in further expanding along the same axis, while providing the output beam Lₒᵤₜ propagation parallel to the input beam. FIGS. 25B and 25C illustrate in a self-explanatory manner two more examples of the circulizer configuration, including respectively a single prism circulizer and two-prism 250A-250B circulizer having a built-in folding of the output beam by 90°.

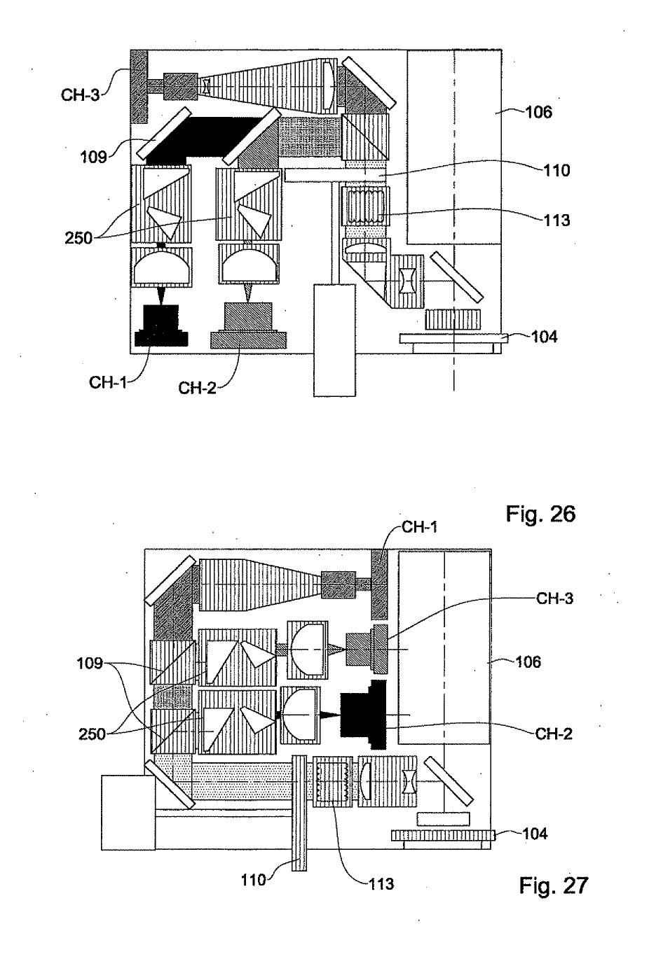

Reference is made to FIGS. 26 and 27 showing two examples of a projector display of the invention utilizing three light channels R-G-B based on laser diode sources and prism circulizers. In these examples, each of the red and blue channels utilizes collimation of emitted light and circulizing (shaping) of the respective beam by a two-prism shaper. In the example of FIG. 26, blue and red light beams are combined by dichroic mirrors and then this combined beam is further combined with a green light beam. In the example of FIG. 27, the green light beam is first combined with the blue one, and then they are combined with the red beam. In both examples, the RGB combined light undergoes random diffusing, shaping by DLMA and condenser lens, modulation by a common reflective-type SLM, and then the modulated light passes through a projection lens.

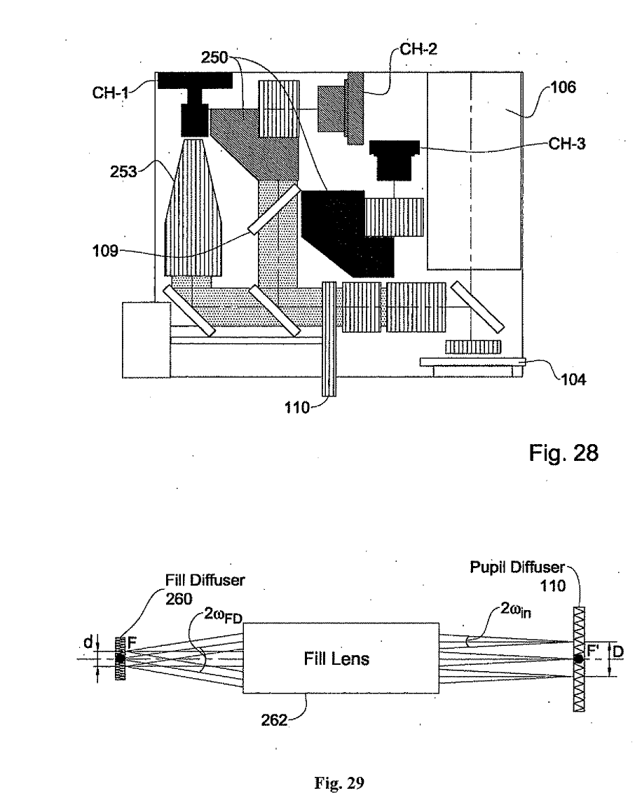

Reference is made to FIG. 28, illustrating another projection display configuration using beam circulizers with built-in beam folding. The red and blue beams are collimated by the collimator lenses. The collimated elliptical beams are circulized by prismatic folded expanders (e.g. anamorphic prism) with built-in folding of the output beam by 90°. Then, the red and blue collimated circular beams are combined by dichroic combiners. This combined beam is then further combined with a parallel green light beam. The green beam is pre-expanded with a Galileo or Kepler telescope.

Reference is made to FIG. 29, illustrating yet another example of the configuration of a beam circulizer, which utilizes diffusing and collimation of a laser beam. As shown, this circulizer comprises a fill diffuser (e.g. diffractive or holographic) 260. The fill diffuser 260 is accommodated at the output of a laser source associated with its collimator. The diffuser 260 is configured and operable to induce certain divergence to the incident collimated beam. Fill diffuser 260 has a circular far-field angular pattern, thus producing a circular cross-section beam. The fill diffuser is preferably placed at the front focal plane of a fill lens 262, while the rotating diffuser 110 (of the de-speckling unit) is placed at the back focal plane of the fill lens 262. As a result, a circular spot with telecentric illumination is obtained on the pupil diffuser 110.

Special considerations should be made, when choosing the diffuser angles for fill diffuser 260, especially in the case of using diffractive diffusers with top-hat far-field profile. Since, the resulting angular pattern is convolution of the input one with the diffuser one. Thus, as much as possible ratio of the diffuser angle to the incident beam divergence is required to keep the maximal part of power inside defined angle. Since, the diffusers are the only elements increasing the geometrical extent of the beam on its way from the laser to the display, the optimal budgeting of that factor is required.

If the diffractive diffusers are used for both fill and pupil diffusers 260 and 110 and the spatial top-hat profile is critical on the same scale for the plane of the illumination system pupil and the plane of the SLM, the diffuser angles can be calculated according to the following procedure:
Calculating the ratio between geometrical extents at the display plane and the laser diode beam

$$K = \frac{{A}_{D} \cdot {NA}_{D}}{{a}_{LD} {NA}_{LD}} \qquad ( 1 )$$

where A_{D} is the display size, NA_{D} is the illumination NA; a_{LD} is the laser diode emitter size at the corresponding direction; and NA_{LD} is the numerical aperture of the beam collected by the collimator lens or at some intensity levels used as a reference.
Calculating the ratio between the output beam angle to the incident one, for each diffuser as

k=\sqrt{K}. (2)
Defining the DMLA angle, for a chosen spot size on the DMLA (pupil size), which, for the optimal pupil filling, has to be equal to the output angle after the pupil diffuser P

$$2 {ω}_{PD}^{′} = 2 {ω}_{DMLA}^{short} = \frac{2 {A}_{D}^{short} {NA}_{D}}{P} \qquad ( 3 )$$

Calculating the diffuser angle as

$$2 {ω}_{PD} = 2 {ω}_{PD}^{′} \sqrt{\frac{k}{k + 1}} \qquad ( 4 )$$

Using the same approach for defining the angle of the fill diffuser.

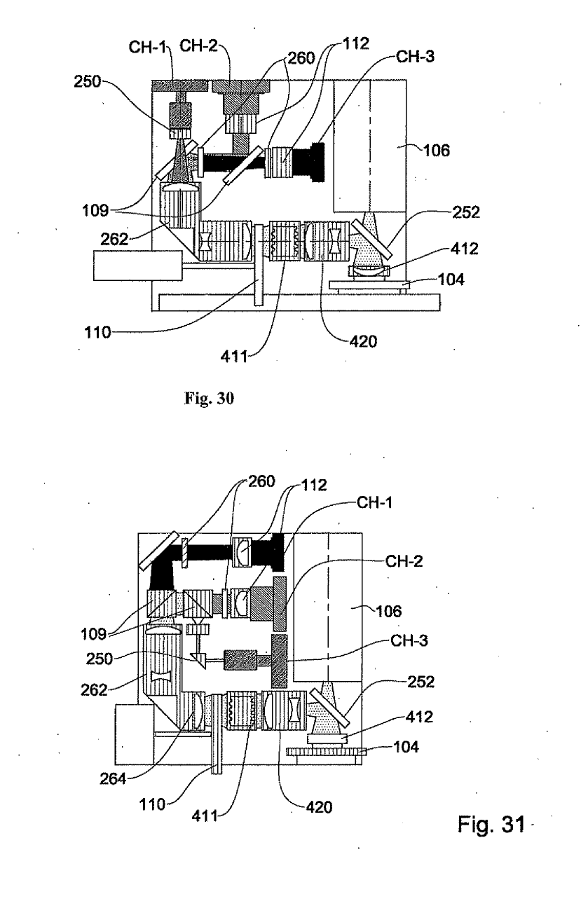

Reference is made to FIG. 30 illustrating a projection display utilizing the above described configuration of a circulizer, namely that having a fill diffuser. In this example, the red and blue light beams are produced by laser sources and a fill diffuser circulizer is thus used, while a green light beam is produced by a DPSS source which is expanded using fill lens as a positive element of the beam expander and additional negative lens 250. The blue light beam is first combined with the red one, this combined beam passes through common circulizer (fill diffuser) 260, and is then combined with the green light beam. A fill lens 262 is implemented as a common module operating as a fill lens collimator for the red and blue channels and as a positive element of the beam expander in the green channel. Since the diffusing angle of fill diffuser 260 depends on the wavelength if using the diffractive diffusers, then using a common diffuser 260 for both the red and blue channels does not result in the same divergence angle. As shown, an additional diffuser 260′ is thus added in the blue channel to equalize between the beam divergences after the fill diffuser for both red and blue channels.

An alternative configuration of the light propagation scheme in the projection display is illustrated in FIG. 31. In this configuration, the red and blue channels have their own fill diffusers 260 inside the channels. The fill lens 262 is configured as a telephoto lens to shorten its mechanical length comparing to the focal length. An additional positive element 264 is added at the output of the fill lens 262 to provide a telecentric pupil at the image side, which is critical for the DMLA.

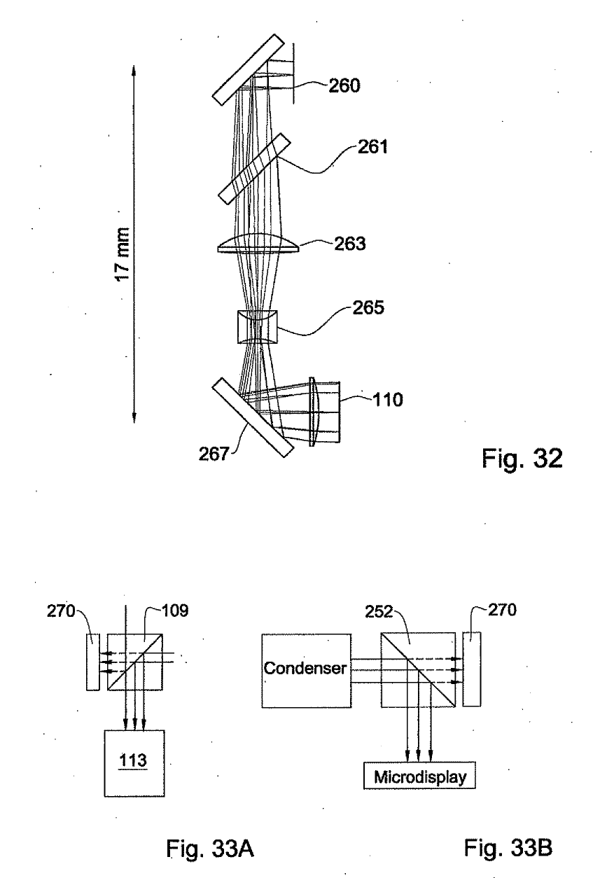

An example of the design of a fill lens unit illustrated for the light path of the blue channel is shown in FIG. 32. The design is done for 30 mm focal length fill lens, while a distance between the fill and pupil diffusers 260 and 110 along the optical axis is 23 mm and a telecentric ray tracing at the pupil diffuser side is provided. The light emerging out the fill diffuser 260 is corrected by the mirror 261 and goes through the dichroic beam combiner 263, transmitting the blue light, while reflecting the red and green one. The positive and negative lenses are operable as a telephoto lens 265, while the following mirror 267 is added to shorten the system size and design the required shape of the projection display. The positive single lens 269 is added as a field lens to provide the telecentric illumination of the pupil diffuser and DMLA.

Reference is made to FIGS. 33A and 33B illustrating a part of the light propagation scheme in the projection display, showing incorporation of a color sensor 270 in the projection display. The color sensor 270 is integrated into the projection display to monitor and correct if needed the white balance due to the variation of the laser power for different colors, associated with temperature changes and long-term power decay. As shown in FIG. 33A, the sensor 270 may be located in the proximity of a dichroic beam combiner 109 (the last one, collecting all the light channels), and oriented so as to collect the multi-channel light output from the beam combiner 109. A beam combiner always has a so-called “active output” which is that through which most of the combined energy is directed along a desired direction, and a so-called “passive output” associated with the propagation of unavoidable “energy loss”. Thus, as shown in the figure, the color sensor 270 is oriented with respect to beam combiner 109 so as to collect light at the passive output of the combiner 109, while the active output of the beam combiner is directed to a beam shaper (e.g. DMLA) 113. Another optional position for the color sensor is in the proximity of a PBS 252, as illustrated in FIG. 33B. The color sensor 270 may be configured as follows: It may include three detectors having three corresponding red, blue and green filters; three detectors with grating; three detectors with dispersive element (prism or other); a spectrometer; or any combination of the above. The color sensor may be positioned in any point after combining the color beams.

Thus, the present invention provides for obtaining a small projection device due to a relatively short light path for one or more channels. Typical mechanical external dimensions (W×L×H) of the mobile projection display of the present invention are in the range from 25×15×6 mm³ up to 120×60×30 mm³. The projector display system of the present invention may provide 6-25 lumen RGB light flux which fits for 6″-20″ screen.

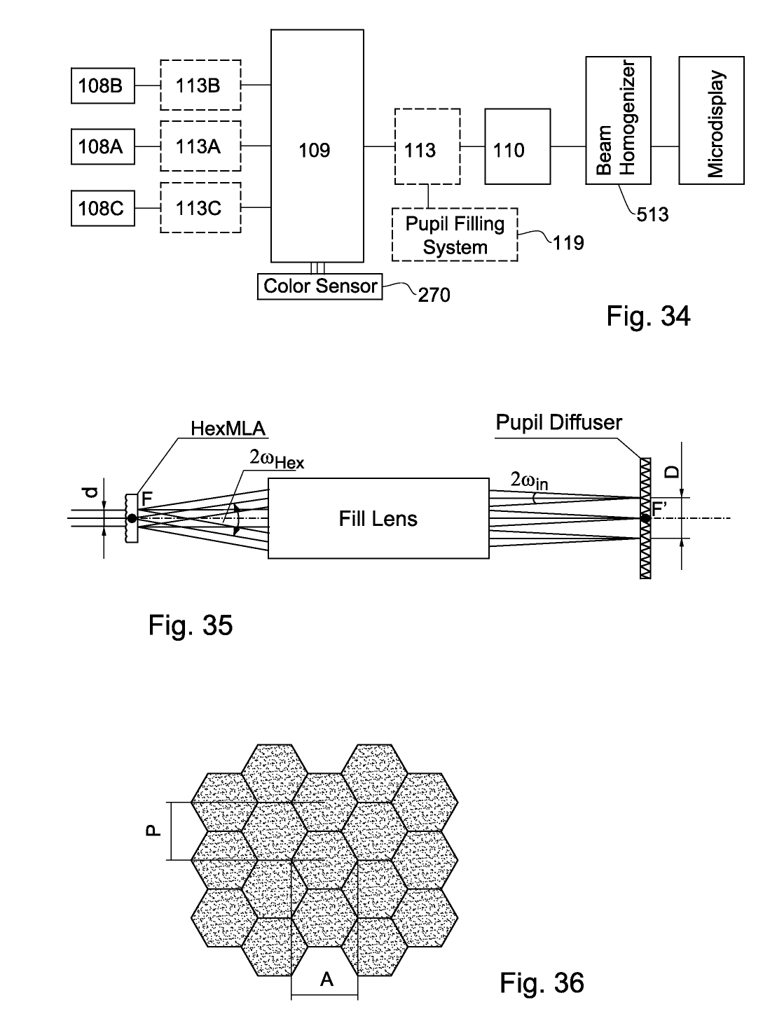

Reference is now made to FIG. 34 showing yet another example of the light propagation scheme in the projection display system of the present invention. This configuration is generally similar to the above described example of FIG. 2. Green, red and blue light beams from three laser sources 108A, 108B and 108C respectively may be each appropriately shaped by beam shapers 113A, 113B and 113C and then combined by a dichroic beam combiner/s 109 associated with a color sensor 270, or may first be combined by beam combiner 109 and then the combined multi-color light beam undergoes beam shaping by a beam shaper unit 113 associated with a pupil filling system 119. The combined and shaped beam (being shaped before or after combining) passes through a speckle reduction unit 110, and a light beam emerging from the speckle reduction unit is processed by a further beam shaper 513 which is configured as a beam homogenizer to provide spatially uniform illumination on a screen surface (microdisplay), which is projected by a projector lens.

Thus, in this configuration, the R-, G- and B-beams are combined and shaped before getting to the speckle reducer. It should be noted that the beam shaping may be performed before the combining of the beams (i.e. being applied to each beam separately), or thereafter being applied to the combined beam. The speckle reduction is done using a moving diffuser, e.g. exploiting the averaging time of the eye (−0.1s).

Preferably, the beam shaping unit 113 includes hexagonal microlens array (HexMLA), which is common for all light channels, thereby providing effective and uniform filling of the projector pupil. The beam shaping unit 113 may include an additional polarizing beam splitter for the improvement of the polarization extinction ratio and, as a result, the system contrast. In this configuration, the illumination path has lower number of optical elements.

It should be noted that generally multiple HexMLAs may be used, being placed in the corresponding color channels before the color combination. This might be constructively advantageous for some applications (while might increase the costs due to HexMLA multiplication).

As indicated above, the present invention is aimed at providing maximal collection efficiency and best image quality to thereby enable a bright and sharp image on the screen at limited power consumption and small footprint (e.g. 25×25 mm max) and volume (e.g. 3 to 5 cc). Using laser sources for three primary colors enable compact designs, high light collection efficiency and slow projection lens, which simplifies the system design. Red and blue laser diodes and green DPSS laser are the light sources, which enable white light generation through the mixing of three basic colors and best color gamut due to the naturally saturated color of lasers (as compared to LEDs or other wideband light sources). Single common HexMLA may be used for all color channels. Color mixing may be implemented using color filter displays or color sequential mode of the display operation. The use of common HexMLA provides uniform filling of the illumination pupil. The use of polarizing beam splitter (PBS) improves the polarization extinction rationi in the illumination beam. If the extinction ratio of one or more laser sources is the limiting factor for the system contrast, using such cleaning PBS provides improvement of the contrast of the projector as measured on the screen. Integration of a special color sensor into the system provides for color monitoring and if needed correcting the white balance that might be required due to the variation of the lasers' power due to temperature changes and long-term power decay. As will be exemplified further below, the sensor is preferably installed downstream the last dichroic beam combiner collecting the light, which is not directed to the homogenizer. The color sensor may be implemented as one of the following or any combination thereof: a single detector synchronized with the laser pulses; three detectors with corresponding red, blue and green filters; a device including a dispersive element such an a diffraction grating or a prism and three detectors each one collecting a specific band (red, green, blue) of the dispersed light; three detectors with dispersive element (prism or other); a spectrometer. The single color sensor may be positioned in any point after combining the primary color beams. Integration of three separate detectors may be done also before combining the beams.

As indicated above, a hexagonal microlens array (HexMLA) may be used instead of the fill diffuser circulizer. This is illustrated in FIG. 35 showing an example of a beam circulizer, which is generally similar to that of FIG. 29, but the fill diffuser of FIG. 29 is replaced here by HexMLA. This provides higher performance in terms of light collection and pupil uniformity.

The pupil filling system is aimed at filling the illumination (condenser) pupil with circular beam, while better collection efficiency and spatial uniformity at the pupil plane are important to optimize the system brightness and image quality. The system of the present invention using HexMLA provides for obtaining hexagonal uniform spot with telecentric illumination on the pupil diffuse, which is the goal of the beam shaping system design. The operation of HexMLA for the pupil filling is similar to that of the fill diffuser, while HexMLA provides higher collection efficiency and better spatial uniformity at the pupil plane. Another advantage of the HexMLA comparing to the diffractive fill diffuser is that its divergence angle is almost insensitive to the wavelength due to its refractive nature.

HexMLA may be easily coated with antireflective coating on both sides to maximize its transmission, while coating holographic diffuser on the diffusing side may be inefficient. Collimated elliptical beams from the red and blue lasers are combined with the green divergent beam using dichroic beam combiners. The divergence of the green beam is chosen such that it is significantly lower than the HexMLA angle and the alignment of the laser beam would not shift it on the HexMLA out its clear aperture. HexMLA is placed at the front focal plane of the fill lens, while the moving pupil diffuser, responsible for the speckle reduction, is placed at the back focal plane of that lens or close to that.

Using hexagonal packing of the microlens array is the optimal one to get the shape closest to the circle, which is the pupil shape, while keeping 100% fill factor of the array. If the fill factor is lower, this results in the drop of the collection efficiency and reduction of the projector brightness at given power consumption. The layout of the lens packing in the HexMLA is exemplified in FIG. 36, where A is the longest hexagonal dimension of the lenslet, and P is the lens pitch.

Hexagonal microlens array may be manufactured using molding, UV embossing, etching, direct writing or other technology. Special considerations is made when choosing the parameters of the lenslets (A and P) and the HexMLA divergence angle. The resulting angular pattern is convolution of the input angular profile with the hexagonal far-field pattern of HexMLA. Thus, the higher the ratio of the HexMLA angle to the incident beam divergence, the higher power is kept inside the defined angle. Consequently, the divergence of the green beam is a compromise between two factors, as follows: On the one hand, it has to be large enough to provide reasonable covering of HexMLA. For example, a minimal number of lenslets covered by the beam is 3×3, but higher the number, better the uniformity at the pupil diffuser. On the other hand, high green beam divergence comparing to the HexMLA angle would cause smearing of the spot at the pupil diffuser and as a result lower collection efficiency. The lenslet size (A and P) is limited at the lower end by increasing a relative area of the transition zones between the lenses, which would cause drop of the collection efficiency. Also, smaller lenlets will cause highly expressed diffraction effects, which will affect the uniformity of the spot on the pupil diffuser.

Turning back to FIGS. 29 and 35, if the HexMLA 260′ is used (FIG. 36) as a pupil fill element 260 (FIG. 29) in combination with the pupil diffuser 110 and the spatial top-hat profile is critical on the same scale for the plane of the pupil diffuser and the plane of the condenser (back DMLA array), the diffuser and HexMLA angles should be calculated according to the procedure described above using equations (1)-(4), and defining the divergence angle of the HexMLA as:

$$2 {ω}_{Hex} = 2 {ω}_{Hex}^{′} \sqrt{\frac{k}{k + 1}} = \frac{2 {A}_{D}^{short} {NA}_{D}}{{A}_{Hex} \sqrt{k ( k + 1 )}} \qquad ( 5 )$$

The lenslet size should be chosen according to the required covering of the array by the laser beam on it

$${a}_{Hex} = \frac{{A}_{Hex}}{N} \qquad ( 6 )$$

and the divergence angle of HexMLA is defined as

$$2 {ω}_{Hex} = \frac{{a}_{Hex}}{{f}_{Hex}} , \qquad ( 7 )$$

where a_{Hex} and f_{Hex} are the (long) size and focal length of the lenslet.

Using the expressions above, the possible combinations between a_{Hex} and f_{Hex} may be calculated.

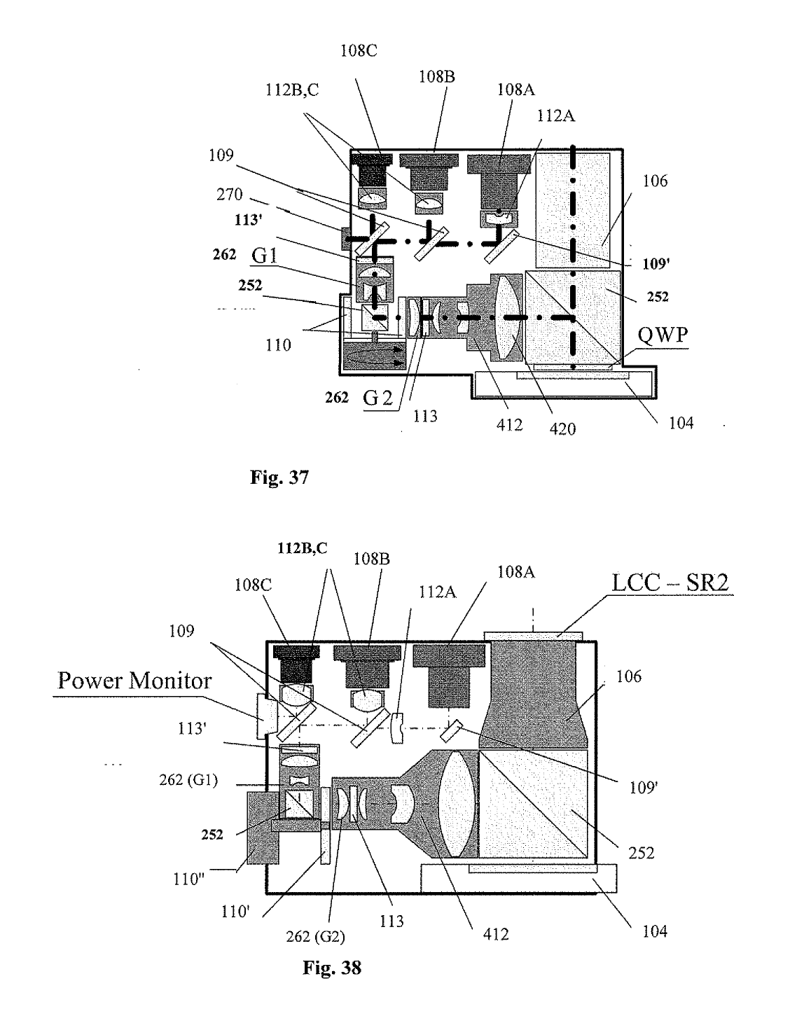

One of the possible optical engine arrangements according to the invention exploiting the hexagonal MLA is illustrated in FIG. 37. Green, red and blue light beams from light sources 108A-108C are shaped by lens units 112A-112C, and then combined using a folding mirror 109′ in the optical path of green light beam and two dichroic combiners 109. Then, the combined light beam is shaped by a hexagonal MLA unit 113′. The fill lens 262 is implemented as two lens units G1 and G2 separated by a PBS 252 responsible for the cleaning polarization of the illumination beam. The first lens unit (G1) may be designed as singlet or double-lens depending on the geometrical dimensions and the focal length. The second lens unit (G2) is the field lens singlet responsible for the telecentric illumination of a DMLA 113. (The pupil diffuser 110 is implemented as a rotating cylinder, while one of the cylinder surfaces (inner or outer) is diffusing. Preferably, the substrate material of the cylinder has very low birefringence (optical glass, quartz, PMMA, etc.). Plane rotating diffuser can also be used as a pupil diffuser.

FIG. 38 shows yet another example of the system of the present invention utilizing hexagonal MLA (113′). Here, the rotating diffuser configuration is used which includes a plane disk diffuser 110′ and a flat type of the motor 110″ (brushless motor). This allows for using a simple diffuser with well-based manufacturing technology, but requires a relatively long motor axis, which effects the motor design.

1. A projection display comprising: an illumination system comprising at least one laser source unit and configured and operable for producing one or more light beams; a spatial light modulating (SLM) system accommodated at output of the illumination system and comprising one or more SLM units for modulating light incident thereon in accordance with image data; and a light projection optics for imaging modulated light onto a projection surface; the illumination system comprising at least one beam shaping unit comprising a Dual Micro-lens Array (DMLA) arrangement formed by front and rear micro-lens arrays (MLA) located in front and rear parallel planes spaced-apart along an optical path of light propagating towards the SLM unit so that each array is placed at the focal plane of the lenslets of the other array, the DMLA arrangement being configured such that each lenslet of the DMLA directs light incident thereon onto the entire active surface of the SLM unit, each lenslet having a geometrical aspect ratio corresponding to an aspect ratio of said active surface of the SLM unit.

2. The projection display of claim 1, wherein each lens of the DMLA defines a substantially rectangular aperture.

3. (canceled)

4. The projection display of claim 1, wherein the illumination system is configured for reducing a speckle effect in the laser light, the illumination system comprising at least one de-speckling unit accommodated in the optical path of the at least one laser beam upstream of the DMLA arrangement.

5. The projection display of claim 4, having at least one of the following configurations: (i) said de-speckling unit is configured and operable to produce a light scattered pattern randomly varying in time and space; and (ii) said laser source unit, said de-speckling unit and said DMLA are configured and operate together such that that the dimension of the cross-section of the light spot on the de-speckling unit is smaller than the dimension of the SLM active surface.

6. The projection display of claim 4, wherein said de-speckling unit comprises a continuously displaceable diffuser configured and operable to produce a light scattered pattern randomly varying in time and space.

7. The projection display of claim 6, having at least one of the following configurations: (a) said continuously displaceable diffuser comprises a rotatable scattering surface; (b) said diffuser is configured and operable to define a diffusing angle such that a sum of divergence of light incident on the diffuser and the diffusing angle of the diffuser is smaller than a field of view of the lenslet; (c) said displaceable diffuser is located in the optical path of light propagating from said laser source unit towards the DMLA arrangement being spaced from the DMLA a certain distance selected so as to avoid imaging of the scattering surface of the diffuser onto the DMLA; and (d) the displaceable diffuser comprises one of the following: a voice coil diffuser, rotationally vibrating diffuser, rotating disc diffuser, and tubular rotating diffuser.

8. (canceled)

9. The projection display of claim 6, wherein the illumination system comprises at least one collimator at the output of said at least one laser source; and said continuously displaceable diffuser is located in the optical path of collimated light propagating towards the DMLA arrangement being spaced from the DMLA a certain distance selected so as to avoid imaging of the scattering surface of the diffuser onto the DMLA.

10. (canceled)

11. (canceled)

12. (canceled)

13. The projection display of claim 1, wherein the DMLA is configured and operable as a de-speckling unit, the illumination system therefore providing for reducing a speckle effect in the laser light.

14. The projection display of claim 1, wherein said illumination system comprises telephoto lenses, such that the optical path of light within the projection display is reduced while the effective focal length of the lenses is maintained.

15. (canceled)

16. (canceled)

17. The projection display of claim 1, wherein the thickness of the DMLA is selected such that the focus of the front MLA is substantially positioned on the surface of the rear MLA.

18. The projection display of claim 1, wherein said laser source unit comprises a light source array associated with collimation optics such that the plurality of beams emitted by the light source array is collimated into one collimated beam; the collimation optics collimating first the slow axis and then the fast axis of the collimated beam.

19. The projection display of claim 1, wherein a light propagation path through said projection display substantially does not exceed a few tens of millimeters.

20. The projection display of claim 1, wherein said illumination system comprises a LED source.

21. The projection display of claim 1, wherein said projection display comprises a set of substantially identical condenser and field lenses oriented in opposite directions, such that the condenser lens is located in proximity of the DMLA and the field lens is located at the rear focal plane of the condenser lens, which is in a close proximity to the SLM.

22. The projection display of claim 1, wherein said at least one beam shaping unit comprises a circulizer located upstream of the DMLA with respect to a light propagation direction towards the SLM.

23. The projection display of claim 22, wherein said circulizer comprises at least one prism.

24. The projection display of claim 22, wherein said circulizer comprises a fill diffuser and a focusing fill lens at the output of said fill diffuser.

25. The projection display of claim 1, comprising a sensor configured and operable to monitor and correct the white balance of the laser source unit.

26. The projection display of claim 25, wherein said sensor is located at a passive output of a beam combiner combining at least two light channels.

27. The projection display of claim 1, comprising polarization optics unit, which is either a separate unit, or is a part of at least one of the illumination and SLM systems.

28. The projection display of claim 22, wherein said circulizer comprises a hexagonal microlens array (HexMLA) performing pupil filling of the illumination system while improving collection efficiency and spatial uniformity at the a pupil plane.

29. The projection display of claim 1, wherein the illumination system comprises a de-speckling unit accommodated in an optical path of light passed through said at least one beam shaping unit.

30. The projection display of claim 29, having one of the following configurations: (1) the light entering the de-speckling unit is a multicolor light, each color component of said light being previously shaped by the respective beam shaper before combining with other shaped color components; and (2) the light entering the de-speckling unit is a multicolor light, different color components of said light being combined into a multicolor beam and shaped by the beam shaping unit.

31. The projection display of claim 29, wherein the illumination system comprises an additional beam shaping unit in an optical path of light output of the de-speckling unit, said additional beam shaping unit being configured as a beam homogenizer to provide spatially uniform illumination to be projected onto the projection surface.

32. The projection display of claim 29, wherein the beam shaping unit comprises a hexagonal microlens array (HexMLA) located at a front focal plane of a fill lens; the de-speckling unit comprises a displaceable pupil diffuser located in a vicinity of a back focal plane of the fill lens.

33. The projection display of claim 32, wherein the illumination system comprises a beam combiner for combining multiple color light components into a combined multicolor light beam; said beam shaping unit being accommodated in an optical path of the combined multicolor light beam.

34. The projection display of claim 33, wherein said pupil diffuser comprises a rotating cylinder having one or light diffusing surfaces.

35. The projection display of claim 33, wherein said pupil diffuser comprises a plane rotating diffuser.
